(19) United States
(12) Patent Application Publication
(10) Pub. No.: US 2021/0053883 A1
(43) Pub. Date: Feb. 25, 2021

(54) COMPOSITE FERTILIZER COMPRISING LAYERED DOUBLE HYDROXIDES

(71) Applicant: University of Copenhagen, Copenhagen K (DK)

(72) Inventors: Jakob MAGID, Holte (DK); Hans Christian BRUUN HANSEN, Lund (SE); Ahmad IMRAN, Copenhagen Ø (DK); Sandra LÓPEZ RAYO, Holte (DK); Sean Daniel Charles PEDRICK-CASE, Copenhagen K (DK); Lars STOUMANN FOSGRAU JENSEN, Brønshøj (DK); Jan KOFOD SCHJØRRING, Frederiksberg C (DK)

(21) Appl. No.: 16/065,363

(22) PCT Filed: Jan. 9, 2017
(86) PCT No.: PCT/DK2017/050002

§ 371 Date: Jun. 22, 2018

(30) Foreign Application Priority Data
Jan. 8, 2016 (DK) PA 2016 70009
Jan. 29, 2016 (DK) PA 2016 70047

(51) Int. Cl. C05C 5/04; C05C 3/00; C05C 9/00; C05C 5/02

(52) U.S. Cl. CPC C05C 5/04; C05C 5/02; C05C 9/00; C05C 3/00

(57) ABSTRACT

The present invention relates to a novel fertilizer with improved efficiency, and in particular with improved micronutrients supply, which furthermore is particularly suitable for near neutral and alkaline soils. The present invention further relates to a composite for a fertilizer containing a first particle containing one or more macronutrient(s) and second particle(s) containing a layered double hydroxide (LDH) containing at least one micronutrient; the second particle is present on the surface of the first particle.

### FIELD OF INVENTION

The present invention relates to a composite for a fertilizer, a method for fertilizing a plant, and the use of the composite as fertilizer.

### BACKGROUND OF INVENTION

Fertilizers are widely used within industrial agriculture and agronomy. The fertilizers provide macronutrients and micronutrients to the plants, where macronutrients refer to nutrients required in larger quantities, and micronutrients refer to nutrients required in smaller quantities. Fertilizers thereby enhance the growth of the plant, improve the plant resistance to diseases, and/or enhance the nutritional content of the plant for the benefit of the plant eater, as well as subsequent links upstream in the food chain.

Fertilizers are traditionally supplied to the soil and/or plant as liquid solutions, or as water soluble solid powder or granules that dissolve upon watering and/or by rainwater, and are thus released to the soil. Traditional solid fertilizers include water soluble ammonium nitrate and chelated iron.

In recent years, layered double hydroxides (LDHs) have been considered as fertilizers. The LDHs may be water soluble depending on pH, and can have a wide range of chemical compositions, and thus comprise several nutrients with fertilizing value. Furthermore, most LDHs are environmentally friendly, which facilitate safe handling of the fertilizer.

EP 1 661 876 [1] discloses a water soluble LDH comprising cations of Fe, Zn, Mn(II), and Cu for exhausted soils. The cations are released to the soil when the LDH is dissolved by watering and/or by rainwater, whereby the nitrate nitrogen is reduced in a crop.

US 2011/296885 [2] discloses a macro nutrient fertilizer intercalated by nano clays, such as LDH. The macronutrient is released to the soil, when the nano clay is dissolved by contact with acidic soil.

LDHs are known to be stable from pH 7 and above. Thus, LDHs are considered for acidic or exhausted soils, where the LDHs are dissolvable.

A further disadvantage of the current fertilizers is the efficiency, i.e. the fertilizer nutrient use efficiency. An efficient fertilizer supplies the crop with nutrients within the sufficiency range. Insufficient supply, as well as excessive supply are detrimental to the efficiency.

Excessive supply is particularly an issue for fertilizers supplying micronutrients, due to the small quantities required. Thus, adequate supply is particularly an issue for fertilizers supplying micronutrients, due to the often very low efficiency. The excessive supply of micronutrients may be toxic to the plant, thus having the adverse effect, and/or the excessive supply is wasted.

The excessive nutrients may be lost by leaching, or become inaccessible to the plants by incorporation into microorganisms, oxidization, or reaction and re-precipitation. The latter is particularly an issue in non-acidic soils, where the excessive cations may become oxidized into e.g. Fe(III) and Mn(IV), which are forms that are inaccessible to plants, or the cations may form water insoluble Zn and Mn phosphates.

Thus, there is a need for fertilizers with improved efficiency, and in particular with improved micronutrient efficiency. The need is particularly prevalent for non-acidic soils with non-acidic conditions, such as near neutral/alkaline soils, or soils cultivated with lime.

### SUMMARY OF INVENTION

The present invention provides a fertilizer with improved micronutrient supply, and improved nutrient use efficiency. The fertilizer further has the advantage of being especially applicable for near neutral and alkaline soils, and the potential for safe handling and low leaching.

In one aspect, the invention relates to a composite for a fertilizer, comprising:
a first particle comprising one or more macronutrient(s), and
at least one second particle comprising a layered double hydroxide (LDH) comprising at least one micronutrient, wherein the at least one second particle is present on the surface of the first particle.

In another aspect there is provided a method for fertilizing a plant, comprising the steps of:
providing the composite as herein described,
adding the composite to the soil,

whereby the composite dissolves in the vicinity of the plant root, thereby supplying micronutrient to the plant within the micronutrient sufficiency range.

The soil pH in the vicinity of the plant root is typically lower than the pH of the surrounding soil. The micronutrients are released from the particles in a pH dependent manner. This means that the micronutrients are preferentially released in the vicinity of plant roots, where they can be taken up. This leads to more efficient use of the applied micronutrients as they are preferentially released where there is a need for them.

The soil may be a near neutral soil or an alkaline soil.

The composites described herein may be used as a fertilizer.

### BRIEF DESCRIPTION OF THE FIGURES

FIG. 1A shows powder X-ray diffraction (XRD) trace of synthesized Mg—Fe(III) LDH interlayered with nitrate, PY_{NO3} (curve a) prepared as in Example 1 b, Mg—Fe(III) LDH interlayered with carbonate, PY_{CO3} (curve b) prepared as in Example 1c, and a Zn-doped Mg—Fe(III) LDH interlayered with nitrate, PY(Zn)_{NO3} (curve c) prepared as in Example 1a.

FIG. 1B shows the infrared (IR) spectrum of synthesized Mg—Fe(III) LDH interlayered with nitrate, PY_{NO3} (curve a) prepared as in Example 1 b, Mg—Fe(III) LDH interlayered with carbonate, PY_{CO3} (curve b) prepared as in Example 1c, and Zn-doped Mg—Fe(III) LDH interlayered with nitrate, PY(Zn)_{NO3} (curve c) prepared as in Example 1a.

FIG. 2A shows powder X-ray diffraction traces of Mg—Mn(III) LDH interlayered with carbonate, and Mn(II)-Al LDH interlayered with nitrate, prepared as in Example 1c and 1d, respectively.

FIG. 2B shows infrared spectrum of Mg—Mn(III) LDH interlayered with carbonate, and Mn(II)-Al LDH interlayered with nitrate prepared as in Example 1c and 1d, respectively.

FIG. 3 shows the Zn concentration in a composite fertilizer, with Zn total (HCl) (shown in blue) and water soluble Zn (H₂O) (shown in red). Composites were made of four different granules, and the granules were coated with Mg—Fe(III) LDH interlayered with nitrate as described in Example 2. The granules were AS, CN, AS+DCD, and DCODER, where AS+DCD refer to AS granules further comprising the nitrification inhibitor (DCD), and DCODER is equivalent to a NPK granule.

FIG. 4 shows Mg and Zn release over time for a solution of incubated Mg—Fe(III) LDH interlayered with nitrate at different pH. The incubated Mg—Fe(III) LDH is further doped with Zn.

FIG. 5 shows Mg and Zn release over time for a solution of incubated Mg—Fe(III) LDH interlayered with carbonate at different pH. The incubated Mg—Fe(III) LDH is further doped with Zn.

FIG. 6 shows Mg and Cu release over time for a solution of incubated Cu(II) doped Mg—Fe(III) LDH interlayered with nitrate at different pH.

FIG. 7 shows Mg and Cu release over time for a solution of incubated Cu(II) doped Mg—Fe(III) LDH interlayered with carbonate at different pH.

FIG. 8 shows Mg and Mn release over time for a solution of incubated Mg—Mn(III) LDH interlayered with carbonate at different pH.

FIG. 9 shows Mn release over time for a solution of incubated Mn(II)-Al LDH interlayered with nitrate at different pH.

FIG. 10A shows the petri dish system from the side (profile view), and FIG. 10B shows the petri dish from the top. Positions suitable for sampling with the DGT technique are indicated.

FIG. 11 shows a schematic of the pots in Example 6, the pot content and distribution.

FIG. 12 shows Zn concentration in shoots of barley plants grown under sand media with the treatments. Different letters indicate statistical differences according to the Duncan test at P≤0.05.

FIG. 13 shows Mn concentration in shoots of barley plants grown under sand media with the treatments. Different letters indicate statistical differences according to the Duncan test at P≤0.05.

FIG. 14 shows Cu concentration in shoots of barley plants grown under sand media with the treatments. Different letters indicate statistical differences according to the Duncan test at P≤0.05.

FIG. 15 shows the position of the seeds and fertilizer in the 2 l pots of Example 7. All numbers are distances in cm.

FIG. 16 shows XRD for PY(Zn)NO₃ LDH samples with and without a silica coating as described in Example 12.

FIG. 17 shows FT-IR for PY(Zn)NO₃ LDH samples with and without a silica coating as described in Example 12.

FIG. 18 shows XRD for MnAl—NO₃ LDH samples with and without a silica coating as described in Example 12.

FIG. 19 shows FT-IR for MnAl—NO₃ LDH samples with and without a silica coating as described in Example 12.

FIG. 20 shows the relative release of metal cations (Mg, Zn, Mn) from LDH samples with and without a silica coating as described in Example 12.

FIG. 21 shows the Mn concentration in shoots of barley plants grown under soil media as described in Example 13.

FIG. 22 shows the pH of the rhizospheric and bulk soil as described in Example 13.

FIG. 23 shows the Mn concentration in the rhizospheric and bulk soil as described in Example 13.

FIG. 24 shows the dry mass of maize plants grown under soil media as described in Example 13.

FIG. 25 shows the Zn concentration in shoots of maize plants grown under soil media as described in Example 13.

FIG. 26 shows the Zn concentration in the remaining soil growing as described in Example 13.

FIG. 27 shows the sampling distances as described in Example 14.

FIG. 28 shows the diffusion of Mn through a calcareous soil (pH 7.3, high in in CaCO₃ and low in Mn, sieved at 2 mm) as described in Example 14. The diffusion of Mn from the fertiliser granules of DCODER or Ammonium sulphate (AS) is shown as a function of time.

### DETAILED DESCRIPTION OF THE INVENTION

Fertilizers may be added to a soil as solid powder or granules. The nutrients present in the fertilizer are then released to the soil, and thus made available to the plants upon dissolution of the fertilizer.

The uptake of the released nutrients in the soil to the plant occurs through the roots. The roots may take up the nutrients by cation exchange, where protons (H⁺) are being pumped from the root, and thus replacing the nutrient cations present in the soil and attached to soil particles, whereby the nutrient cations become available for uptake in the roots.

An efficient fertilizer supplies the soil with nutrients at a comparable rate as the plant root cation exchange or assimilation rate. Thus, the dissolution rate of the fertilizer is a key property for the efficiency. If the dissolution rate is too high, the excess released nutrients may either be wasted or poison the plant. Thus there is a need for fertilizers with a controlled release rate, which is in synchrony with that of the crop.

The present invention relates to a composite of first particles comprising one or more macronutrient(s), and second particles comprising micronutrients, and where the particles of the composite have dissolution profiles, which are surprisingly suitable for meeting plant requirements in regards to both micronutrients and macronutrients. Furthermore, the dissolution profiles are obtainable under rhizosphere conditions in near neutral and alkaline soils, such as the pH conditions present in the vicinity of plant roots in near neutral and alkaline soils.

Nutrients

To obtain optimal plant properties, a plant requires both macronutrients and micronutrients. By the term “macronutrients” is meant nutrients required in larger quantities by plants, which may include nitrogen (N), phosphorus (P), potassium (K), calcium (Ca), magnesium (Mg) and sulfur (S). By the term “micronutrients” is meant nutrients required in smaller quantities by plants, and may include copper (Cu), iron (Fe(II)), manganese (Mn), molybdenum (Mo), zinc (Zn), boron (B), silicon (Si), cobalt (Co), selenium (Se) and vanadium (V). While some micronutrients, such as Zn or Se may only be required in very small amounts for most crops, it may be of much interest to fortify crops with such components for the benefit of animals and humans. Thus biofortification of crops with micronutrients can be a desirable outcome for which the invention may be applied.

For any given plant, the terms micronutrient and macronutrient are mutually exclusive. Thus, the term micronutrient excludes all macronutrients.

The specific amount of nutrients required by a plant, to obtain the optimal plant properties, will depend on the plant species. The required amount, or range, is also referred to as the “nutrient sufficiency range” which generally refers to the elemental concentration in leaves/aerial part of the crop. The concentration of macronutrients is required in the order of magnitude of mg element per g plant while micronutrients are in the order of magnitude of μg element per plant. For example, in Table A, the macronutrients and micronutrients sufficient range of barley and soybean are presented.

TABLE A
Sufficiency range of macronutrients and micronutrients for
barley (Hordeum vulgare) and soybean (Glycine Max). [6]

| | | | |
|---|---|---|---|
| Macronutrients | % | Micronutrients | ppm |

Barley

| | | | |
|---|---|---|---|
| N | 1.75-3.00 | Fe | 21-200 |
| P | 0.20-0.50 | Mn | 25-100 |
| K | 1.50-3.00 | B | 5-100 |
| Ca | 0.30-1.20 | Cu | 5-25 |
| Mg | 0.15-0.50 | Zn | 15-70 |
| S | 0.15-0.40 | Mo | 0.1-0.3 |

Soybean

| | | | |
|---|---|---|---|
| N | 4.00-5.00 | Fe | 21-300 |
| P | 0.25-0.50 | Mn | 30-150 |
| K | 1.70-2.50 | B | 25-60 |
| Ca | 0.35-2.00 | Cu | 10-20 |
| Mg | 0.25-1.00 | Zn | 25-60 |
| s | 0.20-0.40 | Mo | 0.5-1.0 |

Layered Double Hydroxides (LDHs)

The second particles of the present invention comprises one or more layered double hydroxide (LDHs) comprising at least one micronutrient. LDHs are synthetic materials which may contain micronutritional metals such as Zn, Cu and Mn. An example of synthesis of an LDH (MgMnCO₃ LDH) is described in Example 1. A further example of synthesis of LDH is described in Example 8. The micronutrients hosted in the LDH are released when the LDH structure is dissolved.

Structurally, LDHs are nanostructured layered materials, composed of a framework of two-dimensional layers of brucite-type trioctahederal metal hydroxides. The general formula of a LDH may be represented as shown in formula (1) below:

[M^{II}₁₋ₓM^{III}ₓ(OH)₂]^{x+}[Aⁿ⁻_{x/n}].mH₂O (1)

The divalent cation (M^{II}) may be Mg²⁺, Ca²⁺, Co²⁺, Ni²⁺, Zn²⁺, n the trivalent cation (M^{III}) may be Al³⁺, Cr³⁺, Fe³⁺, and Aⁿ⁻ is the interlayer anion such as Cl⁻, NO₃⁻, CO₃²⁻, SO₄²⁻, and ‘m’ is number of water molecules in the interlayer per formula unit.

The composition of the LDH may be varied by substitution of divalent ions by trivalent cations. The substitution will generate a positive charge in the metal hydroxide layers, which is counterbalanced by the anions in the interlayer. The anions in the interlayer are held by electrostatic forces, and thus undergo anion exchange reactions in aqueous medium. The composition and properties of a LDH may further be modified by surface modification, such as by sorption of silicic acid or polymers.

The LDHs may be referred to by chemical abbreviations of the structural formula. Thus, the abbreviation “MgZnFeNO₃” corresponds to the structural formula [(Mg,Zn)^{II}₁₋ₓFe^{III}ₓ(OH)₂]^{x+}[NO₃²⁻_{x/2}].mH₂O, and may also be referred to as “MgZnFe(III)NO₃” or “MgZnFe^{III}NO₃”, or “Zn-doped Mg—Fe(III) LDH”, or “PY(Zn)_{NO3}”.

LDH with the formula [(Mg)^{II}₁₋ₓFe^{III}ₓ(OH)₂]^{x+}[NO₃²⁻_{x/2}].mH₂O, is also referred to as undoped Mg—Fe(III) LDH, and may also be referred to as “PY_{NO3}”.

Correspondingly, the abbreviation “MgZnFeCO₃”, corresponds to the structural formula [(Mg,Zn)^{II}₁₋ₓFe^{III}ₓ(OH)₂]^{x+}[CO₃²⁻_{x/2}].mH₂O, and may also be referred to as “MgZnFe(III)CO₃” or “MgZnFe^{III}CO₃”.

“MgMnCO₃”, corresponds to the structural formula [Mg^{II}₁₋ₓMn^{III}ₓ(OH)₂]^{x+}[CO₃²⁻_{x/2}].mH₂O, and may also be referred to as “MgMn(III)CO₃” or “MgMn^{III}CO₃”, or “MgMn—CO₃ LDH” or PY_{CO3}.

“MnAlNO₃”, corresponds to the structural formula [(Mn)^{II}₁₋ₓAl^{III}ₓ(OH)₂]^{x+}[NO₃²⁻_{x/2}].mH₂O, and may also be referred to as “Mn(II)AlNO₃” or “Mn^{II}AlNO₃”, or “MnAl—NO₃ LDH”.

LDHs comprising Cu may also be referred to as “Cu LDHs”, and LDHs comprising Zn may also be referred to as “Zn LDHs”.

Dissolution of LDH

LDHs are known to generally be stable at pH greater than 7, and to slowly dissolve at lower pH. Compared to the simple metal hydroxides, LDHs are further known to have slower dissolution rates.

Furthermore, for LDHs acting as hosts for micronutrients, it is advantageous that the LDH has a sufficiently low dissolution rate, such that micronutrients are released within the micronutrient sufficiency range.

In the present application, the terms “dissolution rate” and “dissolution profile” are used interchangeably, and refer to the dissolution as a function of time.

The dissolution profile of an LDH will depend on several factors, including:
Particle size
Chemical composition
Adsorption to other particles or to soil surfaces
pH
coating with modifying substances, e.g. silica

In general, the stability of an LDH increases with pH, the size of the particle, and adsorption to other particles. Thus, to obtain LDH dissolutions within a micronutrient sufficiency range, a certain range of pH, size, composition, and adsorption of the LDH are advantageous.

The soil pH in the vicinity of the plant root is typically lower than the pH of the surrounding soil. This is particularly the case, when the nutrients are available for root uptake, which activates the cation exchange mechanism. The cation exchange mechanism includes exudation of protons from the roots, and the proton root release results in a lower pH in the rhizosphere (the vicinity of the roots) than in the surrounding soil.

In an embodiment of the invention, the second particle(s) comprising LDH are configured to dissolve at the pH ranges present in the rhizosphere in near neutral and/or alkaline soils, such as pH ranges between 3.5-6.5, and more preferably between 4-5.

Thus, the micronutrients are released from the LDH particles in a pH dependent manner, and the release rates are controlled by the roots. This means that the micronutrients are preferentially released in the vicinity of plant roots, where they can be taken up.

The micronutrient release rate of a specific micronutrient will also depend on the LDH particle size, as well as the concentration of micronutrients within the LDH.

In an embodiment of the invention, the second particle(s) comprising LDH are micro particles with a particle size equal to or below 10 μm, more preferably below 5, 3 or 1 μm, and most preferably with a diameter between 0.1 and 1 μm.

The dissolution profile also depends on the chemical composition of the LDH. For example, the solubility of the LDH may greatly decrease when Mg²⁺ is replaced with Ni²⁺ and Co²⁺.

In an embodiment of the invention, the LDH comprises one or more micronutrients selected from the group consisting of: copper (Cu), iron (Fe(II)), manganese (Mn), molybdenum (Mo), zinc (Zn), boron (B), silicon (Si), cobalt (Co), vanadium (V), selenium (Se), and combinations thereof, more preferably copper (Cu), manganese (Mn), zinc (Zn), selenium (Se), and combinations thereof.

In a further embodiment, the LDH is selected from the group of: MgZnFeNO₃, MgZnFeCO₃, MgMnCO₃, and MnAlNO₃. In another embodiment, the LDH further comprises one or more anion(s) selected from the group of: anions comprising selenium, such as SeO₄²⁻, and anions of organo-metal complexes comprising divalent manganese, and combinations thereof.

In addition to the dissolution profile, the chemical composition of the LDH affects the release rate of a specific micronutrient. For micronutrients with very small micronutrient sufficiency ranges, it is advantageous that the content of said micronutrient within the LDH is small. Alternatively, it is advantageous that the content of non-micronutrients, such as Al and Fe(III), is high, and that the content of macronutrients, is high.

In an embodiment of the invention, the LDH comprises below 30 wt %, more preferably below 10 or 5 wt %, and most preferably below 3 wt % of any one of the micronutrients.

In another embodiment of the invention, the LDH comprises above 50 wt %, more preferably above 70 wt %, and most preferably above 90 wt % of non-micronutrients, such as magnesium (Mg), and/or aluminium (Al), and/or iron (Fe(III)).

The dissolution of LDH may be tested as described in Examples 3 and 4.

The dissolution profile of an LDH may also be affected by the presence of adsorbed or bonded species. For example, an LDH particle may be surface modified by sorption of silicic acids and/or organic polymers.

In an embodiment of the invention, the LDH is further surface modified by sorption of silicic acids and/or organic polymers.

For example Mn release from the inorganic matrix of LDH may cause Mn toxicity to barley plants, when grown in sand culture. The same may occur when grown in soil-plant systems. Thus, to avoid for example Mn toxicity to plants, the LDH may be surface modified by sorption of silicic acid, or a silica coating. This will have the effect of further controlling the release of micronutrients from LDHs. The process of slowing the release of plant nutrients from fertilizers is also known as slow- or controlled-release fertilizers.

With controlled-release fertilizers, the principal method is to cover a conventional soluble fertilizer with a protective coating (encapsulation) of a water-insoluble, porous material. This controls water penetration and thus the rate of dissolution, and ideally synchronizes nutrient release with the plants' needs. Encapsulation through silica to control the release rate of fertilizers can reduce the loss of fertilizer and minimize environmental pollution.

Particles of silica with diameters between 50 and 2000 nanometers (nm) may be synthesized by the Stöber process, where tetraethyl orthosilicate (TEOS) is added to an excess of water containing a low molar-mass alcohol such as ethanol and containing ammonia.

Example 12 describes an embodiment of the invention, where LDH particles were coated with silica (SiO₂) using TEOS, and the release of micronutrients was compared between coated particles and uncoated samples. A significant slower release rate of micronutrients from LDH coated with silica was observed.

In an embodiment of the invention, the LDH is surface modified by a coating of silica particles. In a further embodiment of the invention, the silica particles are coating above 50%, 60% or 70% of the LDH surface, and more preferably above 80% or 90% of the LDH surface.

Composite

The particle comprising LDH may also be adsorbed or bonded to other particles, and thus be part of a composite. The presence of the composite will affect the LDH dissolution profile. The composite further has the advantage that it facilitates very low release rates of a specific micronutrient within a specific soil volume.

The release rates of micronutrients from a composite comprising LDH depend on both the dissolution profile of the LDH, as well as the structural characteristics of the composite, and the ratio of LDH within the composite.

Advantageous dissolution profiles may be obtained when the particles comprising LDH are present on the surface of the other first particle. Thus, the composite may be formed by coating particles of LDH on the surface of a first particle.

An example of coating LDH particles onto granules of a macrofertiliser is described in Example 2. A further example of coating fertiliser particles with LDH particles is described in Example 9.

In an embodiment of the invention, the second particle(s) comprising LDH cover the surface of the first particle with a coverage degree above 50%, more preferably above 75%, and most preferably 100%.

In an embodiment, the coverage degree is determined by gas adsorption measurements.

In another embodiment, the second particle(s) are coated on the surface of the first particle.

The micronutrient sufficiency range may be very low for some plants. Low release rates of micronutrients that are within the range, are advantageously obtained when the ratio of particles comprising LDH is low within the composite. Low release rates of micronutrients within a specific soil volume are also advantageously obtained, when the volume of particles comprising LDH is relatively low compared to the volume of the first particles or the volume of the composite.

In an embodiment of the invention, the second particle(s) comprising LDH comprises below 30 wt %, more preferably below 20 or 10 wt %, and most preferably below 5 or 3 wt % of the composite.

In another embodiment of the invention, the composite comprises below 9 wt %, more preferably below 5 or 3 wt %, and most preferably below 1 wt % or 0.3 wt % of any one of the micronutrients.

In an embodiment of the invention, the first particle is a granule or a nugget.

In a further embodiment, the first particle has a particle size between 0.5 mm and 2 cm, more preferably between 1 mm and 1 cm, or between 2 mm and 5 mm.

Particle Comprising Macronutrient(s)

The first particle of the composite is a particle comprising one or more macronutrients. When a root is available for nutrient uptake, the cation exchange mechanism may be activated by the presence of a macronutrient, such as nitrogen and/or nitrate. Thus, proton root release and associated pH decrease, may be activated by the first particle of the composite comprising the macronutrient.

Therefore, the composite of the present invention has the advantage that the pH controlled release of micronutrients may occur on demand, i.e. the micronutrients are released simultaneously with the roots becoming available for macronutrient uptake.

The cation exchange mechanism will depend on the type of the macronutrient present, such as the oxidation state and/or the charge of the macronutrient, and inherently, the release rates of micronutrients will be affected by the type of macronutrient.

Advantageous release rates of micronutrients are obtained when the first particle comprises one or more macronutrient(s) selected from the group consisting of: nitrogen (N), phosphorus (P), potassium (K), calcium (Ca), magnesium (Mg), sulfur (S), and combinations thereof.

In an embodiment of the invention, the first particle comprises one or more macronutrient(s) selected from the group consisting of: nitrogen (N), phosphorus (P), potassium (K), calcium (Ca), magnesium (Mg), sulphur (S), and combinations thereof.

In a further embodiment of the invention, the first particle comprises nitrogen (N) in the form of: ammonium (NH₄⁺), nitrate (NO₃⁻), and/or urea (CH₄N₂O), such as ammonium sulphate, or calcium nitrate.

In another embodiment of the invention, the first particle further comprises a nitrification inhibitor, such as DCD.

Examples of particles comprising macronutrient(s) are commercially available granules, such as AS (ammonium sulphate), CN (calcium nitrate) and NPK granules. An example of NPK granules is DCODER granules from Navarra, for example D-CODER RCF 7-10-6.

Fertilizing Method

The composite of the present invention may be used for fertilizing a plant in soil, such as barley or soy plants, where the plant roots are capable of performing the cation exchange mechanism.

Advantageously, the composite is added the soil as a solid granular fertilizer.

The method for fertilizing comprises the steps of:
providing the composite,
adding the composite to the soil,

whereby the composite dissolves in the vicinity of the plant root, thereby supplying micronutrient to the plant within the micronutrient sufficiency range.

Advantageously, the method for fertilizing is applied to soil selected from the group consisting of near neutral soils and alkaline soils

Examples of the micronutrient release from LDHs under simulated rhizosphere conditions are described in Examples 3 and 4, which further describes respectively the solubility of LDH as function of pH and time, and the nutrient release of the LDHs at different pH over time. In Example 5 the micronutrient release on soils of different pH is demonstrated. Similar to Example 5, the nutrient release on soils of different pH is further exemplified in Examples 10 and 14

Micronutrient uptake within the micronutrient sufficiency range, may be obtained by fertilizing a plant with composites according to the present invention. Examples 6 and 7 show uptake of micronutrients in barley plants in respectively sand and soil media. Examples 11 and 13 further show uptake in barley and maize plants on soil growing media.

### EXAMPLES

The invention is further described by the examples provided below.

### Example 1: Synthesis of LDH

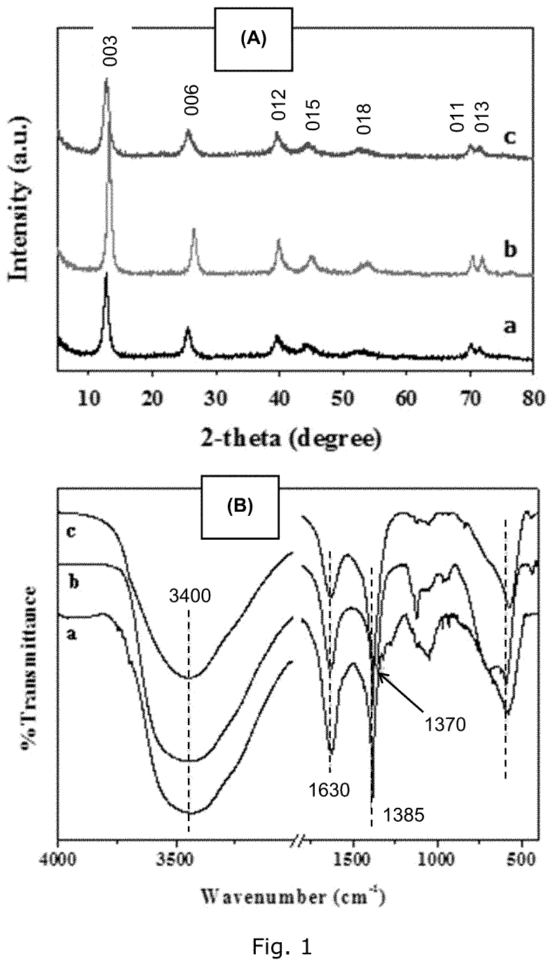

FIG. 1A shows the powder X-ray diffraction trace of synthesized PY_{NO3} (curve a) prepared as in Example 1 b, PY_{CO3} (curve b) prepared as in Example 1c, and PY(Zn)_{NO3} (curve c) prepared as in Example 1a.

FIG. 1B shows the infrared spectrum of synthesized PY_{NO3} (curve a) prepared as in Example 1 b, PY_{CO3} (curve b) prepared as in Example 1c, and PY(Zn)_{NO3} (curve c) prepared as in Example 1a.

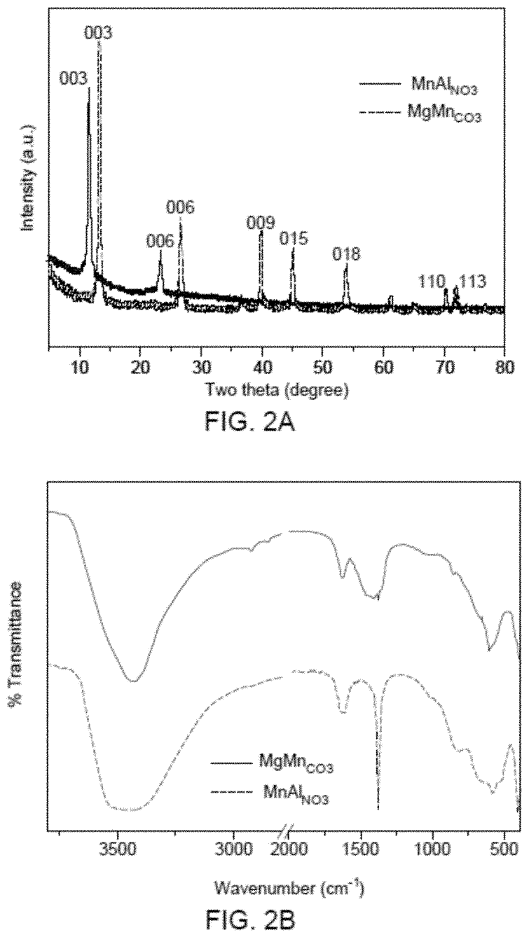

FIG. 2A shows powder XRD of MgMn—CO₃ and MnAl—NO₃ LDH prepared as in Example 1c and 1 d, respectively.

FIG. 2B shows FT-IR spectrum of MgMn—CO₃ and MnAl—NO₃ LDH prepared as in Example 1c and 1 d, respectively.

a) Synthesis of Zn-doped nitrate interlayered Mg—Fe(III) LDH (PY(Zn)_{NO3}) LDH with the formula [(Mg,Zn)^{II}₁₋ₓFe^{III}ₓ(OH)₂]^{x+}[NO₃²⁻_{x/2}].mH₂O, is also referred to as the nitrate form of Zn doped Mg—Fe(III) LDH, and also referred to as namely PY(Zn)_{NO3}.

The nitrate form of Zn doped Mg—Fe(III) LDH can be prepared by a constant pH co-precipitation method.

An aqueous solution of Fe(NO₃)₃.9H₂O (0.1 mol/L) is added drop wise to a mixed solution of Mg(NO₃)₂.6H₂O (0.2 mol/L) and Zn(NO₃)₂ (0.016 mol/L) (metal ion molar ratio MOD/M(III)=2) and [Zn/(Zn+Mg+Fe)=0.05] with constant magnetic stirring (PTFE oval magnetic spinning bar, 25×12 mm, 600 rpm) overnight at room temperature. During the metal ion addition, the pH of the reaction mixture is maintained at 9.5±0.2 using a ‘Metrohm 719S’ Titrino by automatic addition of a freshly prepared carbonate free 1.0 M NaOH solution. A ‘Metrohm 6.0262.100 pH 0-13/0-80° C.’ electrode was used which is calibrated with pH buffers 4.0 and 7.0. The mixture solution is constantly kept under a flow of argon (Ar) gas to hinder access of CO₂ and hence, to avoid contamination with carbonate. Finally, the precipitate is centrifuged (2860 g), washed three times with water-ethanol (50%-EtOH) mixture and dried overnight in an oven at 65° C.

b) Synthesis of Undoped Nitrate Interlayered Mg—Fe(III) LDH (PY_{NO3})

LDH with the formula [(Mg)^{II}₁₋ₓFe^{III}ₓ(OH)₂]^{x+}[NO₃²⁻_{x/2}].mH₂O, is also referred to as undoped Mg—Fe(III) LDH, or PY_{NO3}.

The undoped Mg—Fe(III) LDH namely PY_{NO3} is synthesized by drop wise adding a 0.1 mol/L solution of Fe(NO₃)₃ to a 0.2 mol/L solution of Mg(NO₃)₂ (molar ratio Mg/Fe=2) and maintained at a constant pH of 9.5±0.2, as described above. The corresponding carbonate form (PY_{CO3}) is obtained by ion exchange of the PY_{NO3}; 1.0 g of PY_{NO3} is dispersed in 100 mL of 0.1 mol/L Na₂CO₃ solution for 3 h, followed by centrifugation and washing as described above.

c) Synthesis of Carbonate Interlayered MgMn^{III}—CO₃ LDH (PY_{CO3})

MgMn—CO₃ LDH also known as ‘desautelsite’ is synthesized by a constant-pH co-precipitation method. A mixed solution (100 ml) containing 0.03 mol/L Mg(NO₃)₂ and 0.01 mol/L MnCl₂ (metal ion molar ratio Mg/Mn=3) is slowly added in drop-wise manner to another 100 ml solution containing 0.2 mol/L NaOH and 0.1 mol/L Na₂CO₃, which is stirred magnetically overnight. The pH of the suspension was maintained at 9. Air was bubbled into the suspension through a capillary tube, and the flow rate was controlled.

The resulting precipitates is separated by centrifugation and washed repeatedly with deionized water, then air-dried at room temperature.

d) Synthesis of Nitrate Interlayered Mn^{II}Al—NO₃ LDH

Similarly, a constant-pH co-precipitation method can be utilized to prepare Mn^{II}Al—NO₃ LDH. A 100 ml aqueous solution of 0.66 mol/L Mn(NO₃)₂.4H₂O and 0.33 mol/L Al(NO₃)_{3.9}H₂O (metal ion molar ratio Mn/Al=2) is added drop wise to 100 ml guest inorganic anion solution of 1 mol/L NaNO₃ with constant magnetic stirring overnight. During the metal ion addition, the pH of the reaction mixture has been maintained at 9.0±0.2 using a ‘Metrohm 719S’ Titrino by automatic addition of a freshly prepared carbonate-free 1.0 mol/L NaOH. The mixture solution is stirred overnight at room temperature under the flow of argon (Ar) gas to hinder access of CO₂ and hence to avoid contamination with bicarbonate. Finally, the precipitate is centrifuged, washed three times with water-ethanol mixture and dried overnight at room temperature.

### Example 2: Coating of Fertiliser Particles with LDH Particles

The procedure may be a downscaling of standard factory procedures, and thus reflect a well-known industrial fertiliser coating process.

Equipment Needed
A controllable, rotating stainless steel drum
Pipette (100-1000 μl)
Weighing scale with precision to 0.001 g
ECOLUBE 150 oil (provided by Timac Agro)
LDH powder
Talcum powder
Fertilizer granules
A small metal spoon

Procedure
1) Weigh 30 g of N fertilizer granules (sieved to a consistent size).
2) Angle the rotating drum backwards (˜20 degrees from vertical).
3) Weigh the required amount of LDH powder and talcum powder in small plastic containers.
4) Mix the powders together in another container.
5) Pour the granules into the drum. Turn on the rotation and set the speed, for example to nine or ten.
6) Pipette the oil (˜16 μl per g fertilizer granules) and slowly add it, drop by drop, over the fertilizer granules while they are rotating in the drum. From testing, it seems better if you add half of this to the granules, then add some powder, then add the rest of the oil. N.B. If the granules start to stick to the side of the drum during the process, you have added too much oil; you should add some powder to dislodge it.
7) Use a plastic spoon/spatula/weighing container to add the powder to the granules little by little (use plastic to avoid contaminating the fertilizers with metals).
8) You can use a plastic weighing container to dislodge any oil/granules that have become stuck to the rotating drum.
9) Only prepare one type of LDH fertilizer at a time; in between you need to clean and dry the drum following step 11 below.
10) Place the coated fertilizers in a container where they can spread out in a thin layer to dry, preferably under a vent. Leave for at least 15 minutes). Afterwards, put the fertilizers in a plastic bag.
11) After finishing with one LDH coating treatment, clean the inside of the stainless steel drum. Use only water and kitchen roll to wash and wipe the drum. Wait until the drum is completely dry before trying to coat any more fertilizers.

Characterisation of the Micronutrient Content in the Fertilizers

A characterisation of the coated fertiliser particles has been done to analyse their homogeneity. For that, the official methods for micronutrient fertilizers have been applied (method 8.1 of European Commission Regulation 2003/2003): weight 0.20 g of fertilizer and add 40 ml of water (for the analysis of metal concentration in the soluble fraction) and, additionally, 4 ml of HCl 1:1 (for the analysis of the total metal concentration), bring to the boil and maintain for 20 minutes. Allow to cool, stirring occasionally. Decant quantitatively in 50 ml graduate flask. Make up to volume with water, mix, and filter.

The concentration of Zn or Mn in the sample is analyzed by Atomic Absorption Spectrophotometry.

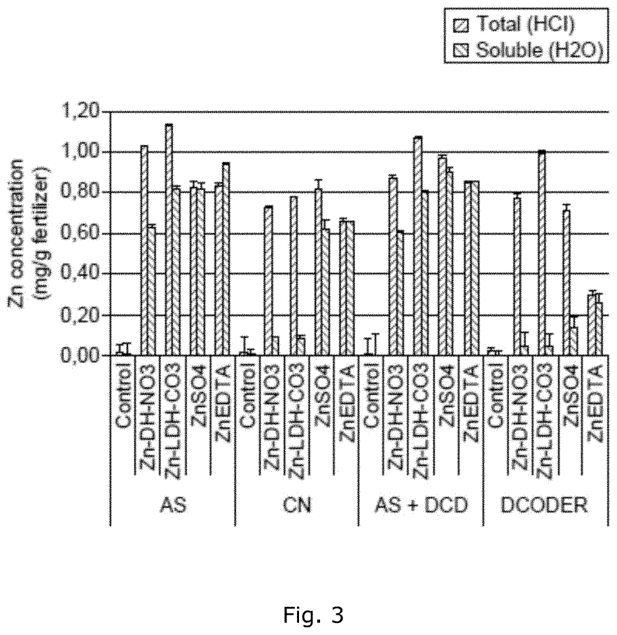

As example, the analysis of the coated fertilisers made with AS, CN and NPK granules coated with the Zn LDH (MgFeZnNO₃) is shown in the FIG. 3, which illustrated the homogeneity of the particles.

FIG. 3 shows the Zn concentration in a composite fertilizers, with Zn total (shown in blue) and Zn soluble (shown in red). Composites were made of four different granules, and the granules were coated with MgFeZnNO₃ LDH. The granules were AS, CN, AS+DCD, and DCODER, where AS+DCD refer to AS granules further comprising the nitrification inhibitor (DCD), and DCODER is equivalent to a NPK granule.

### Example 3: Characterization of the Synthetized LDH's, Before the Coating of Fertilizer Particles with LDH Particles

The solubility of the LDHs is studied according to the total nutrient content (HCl 35%), water-soluble nutrient, available nutrient content (simulated with DTPA extraction), and soluble in citric acid (2%).

The method using the fraction soluble in citric acid simulates the fraction of fertilizer insoluble in water but potentially soluble in the rhizospheric acids. This method is essential in the characterization of our fertilizer taking into account its characteristics as low-release or controlled-release nutrient fertilizer.

Materials and Experimental Method
Determination of total Magnesium and micro-nutrient contents (Method 8.1 of EC 2003/2003): weigh 0.25 g of fertilizer, add 40 ml of water and 4 ml of HCl 1:1 (taking care when the sample contains a significant quantity of carbonate). Bring to the boil and maintain for 20 minutes. Allow to cool, stirring occasionally. Decant quantitatively in 50 ml graduate flask. Make up to volume with water, and mix. Pass through a dry filter into a dry container.
Determination of water-soluble Magnesium and micro-nutrient contents (Method 8.3 of EC 2003/2003): weigh 0.25 g of fertilizer, add 40 ml of water and boil for 25 minutes (at room temperature for the determination of micronutrient content). Allow to cool, stirring occasionally. Decant quantitatively in 50 ml graduate flask. Make up to volume with water, and mix. Pass through a dry filter into a dry container.
Determination of Magnesium and micro-nutrient contents extracted with citric acid: weigh 0.25 g of fertilizer, add 40 ml of citric acid (2%) and boil for 20 minutes (at room temperature for the determination of micronutrient content). Allow to cool, stirring occasionally. Decant quantitatively in 50 ml graduate flask. Make up to volume with water, and mix. Pass through a dry filter into a dry container.
Determination of Magnesium and micro-nutrient contents extracted with DTPA: this fraction represents the plant available fraction. Weigh 0.25 g of fertilizer in a falcon tube, add 40 ml of DTPA extracting solution, and shake for 1 h at room temperature. Then, centrifuge the tubes at 6500 rpm for 10 min and filter the samples with a Millipore 0.45 μM device.

The concentration of Zn, Mn and other metals is analyzed by Atomic Absorption Spectrophotometry.

Results

The results are shown in Table 1. Similar results were obtained when LDHs were dissolved in hydrochloric acid or citric acid. However the dissolution with water did not dissolve any metal, demonstrating the stability of the LDHs at neutral pH. This means that the acidic root exudation would dissolve the total metal contain while the LDH will not be affect by the water content or irrigation practices in the soil.

TABLE 1
Nutrient concentration of LDHs in total, citric,
available (DTPA) and water fractions.

| | MgFeZn NO₃ | | | MgFeZn CO₃ | | |
|---|---|---|---|---|---|---|
| | Mg (%) | Fe (%) | Zn (%) | Mg (%) | Fe (%) | Zn (%) |
| Total | 18.70 | 24.92 | 4.46 | 20.58 | 26.85 | 4.56 |
| Citric | 18.07 | 24.66 | 4.30 | 19.38 | 26.02 | 4.28 |
| DTPA | 6.24 | 0.0021 | 1.45 | 7.19 | 0.0021 | 2.03 |
| Water | 0.00 | 0.00 | 0.00 | 0.00 | 0.00 | 0.00 |
| | MgFeCu NO₃ | | | MgFeCu CO₃ | | |
| | Mg (%) | Fe (%) | Cu (%) | Mg (%) | Fe (%) | Cu (%) |
| Total | 19.44 | 26.52 | 4.23 | 19.43 | 25.15 | 4.04 |
| Citric | 18.26 | 25.72 | 4.17 | 18.36 | 24.65 | 4.03 |
| DTPA | 7.63 | 0.0024 | 1.66 | 7.49 | 0.0024 | 1.95 |
| Water | 0.00 | 0.00 | 0.00 | 0.00 | 0.00 | 0.00 |

| | MgMn CO₃ | | MnAl NO₃ | |
|---|---|---|---|---|
| | Mg (%) | Mn (%) | Al (%) | Mn (%) |
| Total | 20.09 | 9.65 | 7.52 | 32.25 |
| Citric | 19.80 | 16.23 | 8.30 | 33.37 |
| DTPA | 6.94 | 4.27 | 0.28 | 6.61 |
| Water | 0.00 | 0.00 | 0.00 | 3.82 |

### Example 4: Nutrient Release of the LDHs at Different pH Over Time

In order to study the nutrient release at different soil pH conditions, batch experiment are developed to study the kinetics of the nutrient release at rhizospheric and agronomical pHs (5, 6, 7, 8) over the time (1-28 days) in aqueous solutions.

Materials and Experimental Methods

5 mg of LDHs will be incubated in 50 ml water-buffered solution at several pH (5.2 (MES), 5.5 (MES), 6.0 (MES), 7.1 (HEPES), 8.1 (HEPES) 10 mM of each buffer) in closed plastic containers. During the incubation time, samples were kept at 20° C. at 60 rpm orbital shaken. Aliquots of the solutions will be sampled at different times (1, 3, 7, 14, 28 days), filtered and Mg, Zn, Mn and Al analysis by AAS.

Results

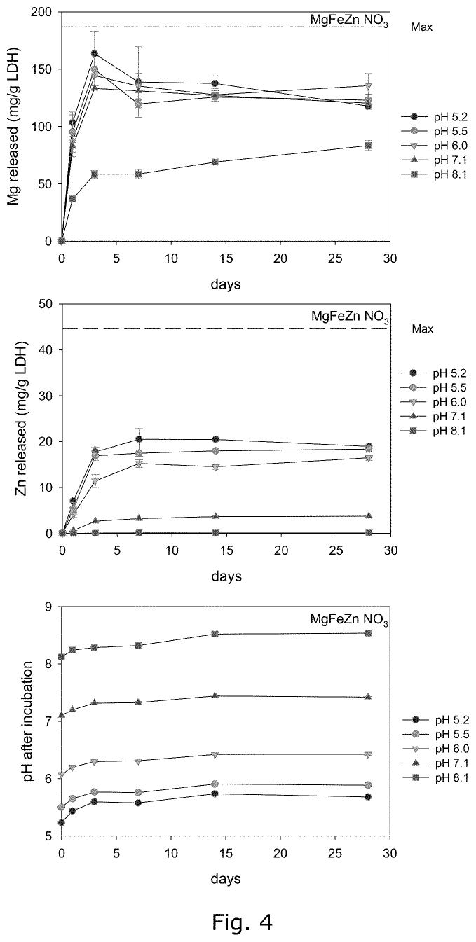

Results are shown in FIGS. 4-9. Each Figure shows an upper, middle, and lower graph. The upper and middle graph show the nutrient release as a function of time for different final pH of the solution incubated DH, and the lower graph shows the pH of the solution as a function of time.

FIG. 4 shows Mg and Zn release over time for a solution of incubated MgFeZnNO₃ LDH at different pH.

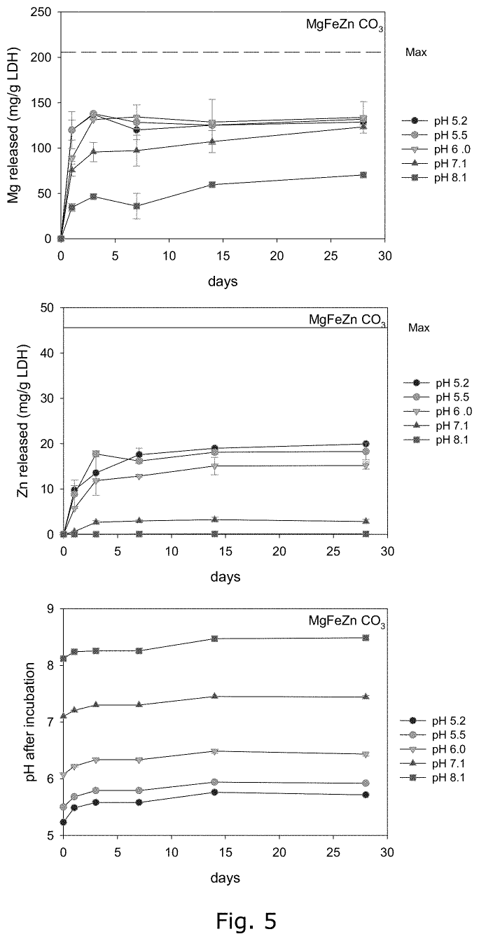

FIG. 5 shows Mg and Zn release over time for a solution of incubated MgFeZnCO₃ LDH at different pH.

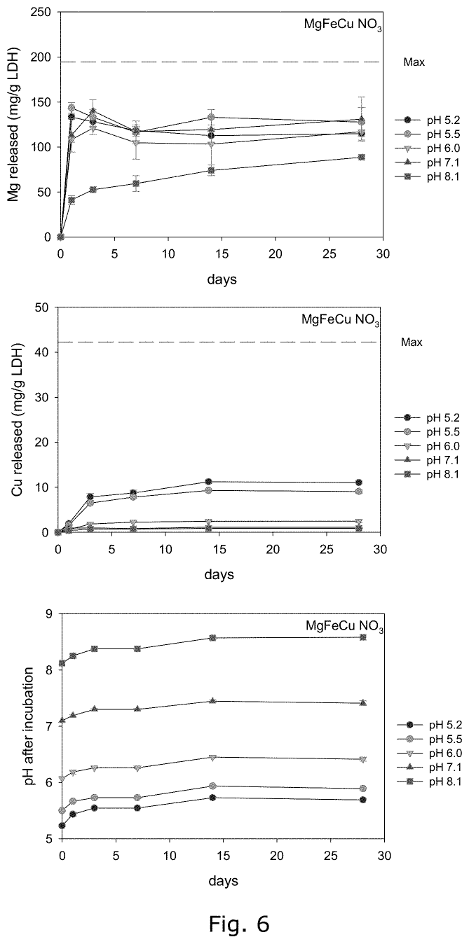

FIG. 6 shows Mg and Cu release over time for a solution of incubated MgFeCuNO₃ LDH at different pH.

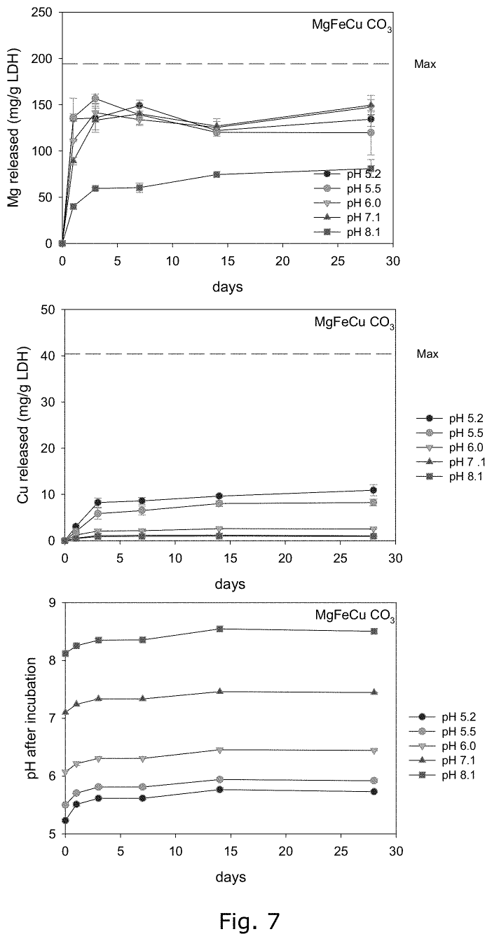

FIG. 7 shows Mg and Cu release over time for a solution of incubated MgFeCuCO₃ LDH at different pH.

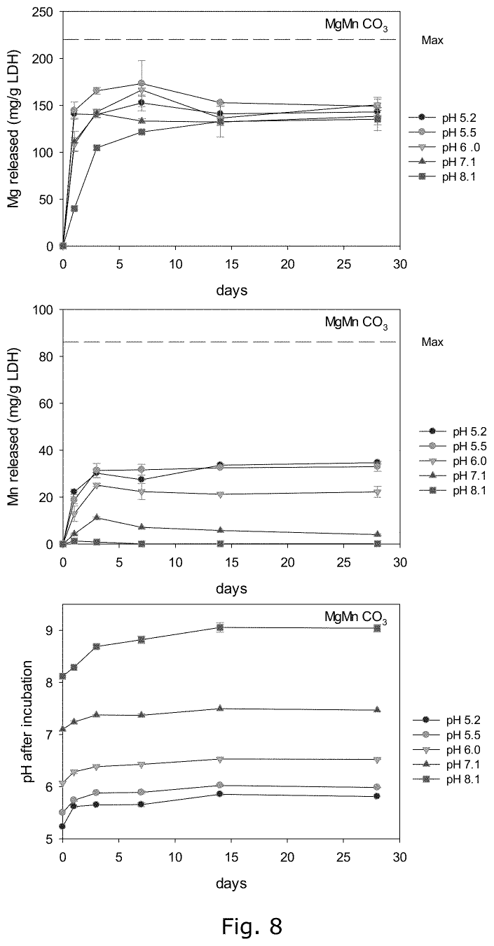

FIG. 8 shows Mg and Mn release over time for a solution of incubated MgMnCO₃ LDH at different pH.

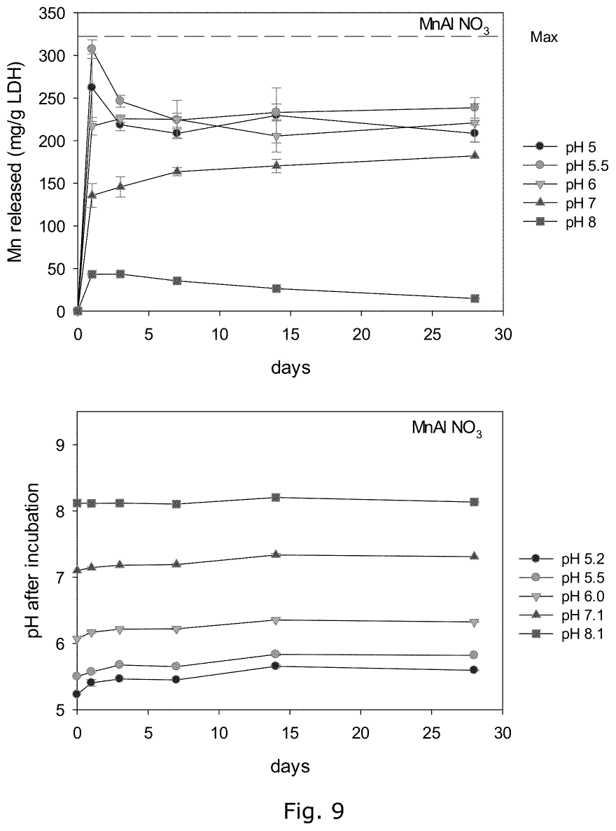

FIG. 9 shows Mn release over time for a solution of incubated MnAlNO₃ LDH at different pH.

According to the results obtained and shown in FIGS. 4 to 9, the release of Zn, Cu or Mn in each LDH was highly dependent on the pH and time. For instance, no metal release was observed at pH 8. At pH 7 the micronutrients were shortly dissolved at a maximum rate of 5-10%. The dissolution increased by decreasing the pH. At estimated pH of the rhizosphere (pH 5), the micronutrients will be dissolved at a higher extent. The Mg release is, in contrast, higher than that for micronutrients, and its dependency with the pH lower. Interestingly, no Al release was observed in the MnAlNO₃ (cf. FIG. 9), indicating that the Al will not be release to the plant, avoiding any toxic effect.

### Example 5: Nutrient Release on Soils of Different pH

Composites comprising LDHs are added to three soils of varying acidity: acid (5.5), neutral (7.0), and alkaline (8.0).

Zinc (Zn) and Manganese (Mn) LDHs are coated on several different fertilizers (the D-CODER RCF 7-10-6, ammonium sulphate, and calcium nitrate fertilizers). A small amount of fertilizer granule (0.1 g) is placed in the centre of a petri dish.

Three different soils of pH 5.5, 7 and 8 are used. The different soils have different soil characteristics affecting diffusion such as water holding capacity (WHC), texture, organic matter content, tortuosity and others. To reduce the problem of soil heterogeneity, the soils will be sieved to 2 mm.

The soil is wetted to 60% WHC and incubated for 7 days at 22/18° C. (day/night) in the growth chamber. After 7 days, a DGT strip is placed on the soil for 24 hours to collect phosphorous and zinc/manganese from an area 3×2 cm, afterwards analysed by laser ablation or split into three pieces (centred at 0.5, 1.5, and 2.5 cm from the fertilizer granules) and analysed with ICP-OES/MS. On the opposite side of the petri dish, soil is analysed at three locations 0.5, 1.5, and 2.5 cm and analysed for P, Zn/Mn after digestion and ICP-OES/MS analysis.

Materials

LDH: controlled-release fertilizer containing Zn (MgFeZnNO₃), or Mn (MnAlNO₃). Fertilizer granules: NPK granules from Navarra (D-CODER 7-10-6, ammonium sulphate granules from Swedane and calcium nitrate granules from Yara Incubation systems: Plastic petri dishes (diameter 8.8 cm, height 1.4 cm).

Soils:
1. Unfertilised soil from the nutrient depletion trial plot B1 (pH ˜5.5, no P received, 60 kg ha⁻¹ N and K, 25 kg ha⁻¹ S)
2. Unfertilised soil from CRUCIAL experiment (plot B5, pH ˜7).
3. Spanish soil (Valencia) from Sandra (pH ˜8.0)

The properties of the three soils used in the soil release experiment are shown in Table 2.

TABLE 2

| | Nut. Dep. | CRUCIAL | Spanish soil |
|---|---|---|---|
| | Trial B1 | unfertilised | Valencia |
| Soil treatment | treatment | (B5) | (Moncada) |
| pH | 5.5 | 7.0 | 8.0 |
| P analysis method | Olsen P | Olsen P | ? |
| P content (mg kg⁻¹) | 11 | 13-15 | ? |
| Zn content (mg kg⁻¹) | 45.0 | 1.7 | 6.3 |
| Mn content | ? | 7.5 | 39.0 |
| (mg kg⁻¹) | | | |
| Total C (%) | 1.2 | 1.4 | ? |
| Total N (%) | 0.13 | 0.13 | 0.14 |
| Sand (%) | 65 | 65 | 60 |
| Silt (%) | 18 | 16 | 24 |
| Clay (%) | 15 | 16 | 16 |

Experimental Method

Three air-dried soils of differing pH (5.5-7-8) are sieved to 2 mm. A petri dish (diameter 8.8 cm, height 1.4 cm) is filled with of soil to a height of 0.5 cm, packed at a density of 1.3 g cm⁻³ and wetted to 60% WHC¹ by dripping water onto the soil. The dishes are covered (e.g. with a plastic cap), and left to equilibrate overnight. A small amount (0.1 g or more) of fertilizer granules (RCF granules from Navarra, ammonium sulphate, and calcium nitrate) is placed in the centre of the petri dish. The granules are covered in a Zn or Mn LDH product as shown in Table 3 below.

TABLE 3
The amount of LDH covering the granules and
the amount of target element released to soil:

| | | | | Zn or Mn |
|---|---|---|---|---|
| | | | | from |
| | | | | fertilizer |
| | | | | expected |
| | Weight Zn | Weight of | | in DGT |
| | or Mn (% | granules | Zn or Mn | or DTPA |
| | of granule | added to soil | added to | sampling |
| Product | weight) | (g) | soil (ng) | area* (ng) |
| NPK 7-10-6 | 0.05% | 0.1 | 50 | 20 |
| MgZnFeNO₃ | | | | |
| NPK 7-10-6 | 0.19% | 0.1 | 190 | 76 |
| MgMnCO₃ | | | | |
| NPK 7-10-6 | 0.29% | 0.1 | 290 | 116 |
| MnAINO₃ | | | | |
| AS MgZnFeNO₃ | 0.11% | 0.1 | 105 | 42 |
| AS MnAINO₃ | 0.21% | 0.1 | 210 | 84 |
| CN MgZnFeNO₃ | 0.08% | 0.1 | 77.5 | 31 |
| CN MnAINO₃ | 0.16% | 0.1 | 155 | 62 |

*Assumed to be 40% of total because DGT sheet is placed to one side of fertilizer pellet

The granules are placed at the centre of the petri dish. The petri dishes are incubated for 7 days or more in controlled temperature conditions (22/18° C., day/night) in a growth chamber or in the basement. On the seventh day (or later), the granules are removed and replaced with sand.

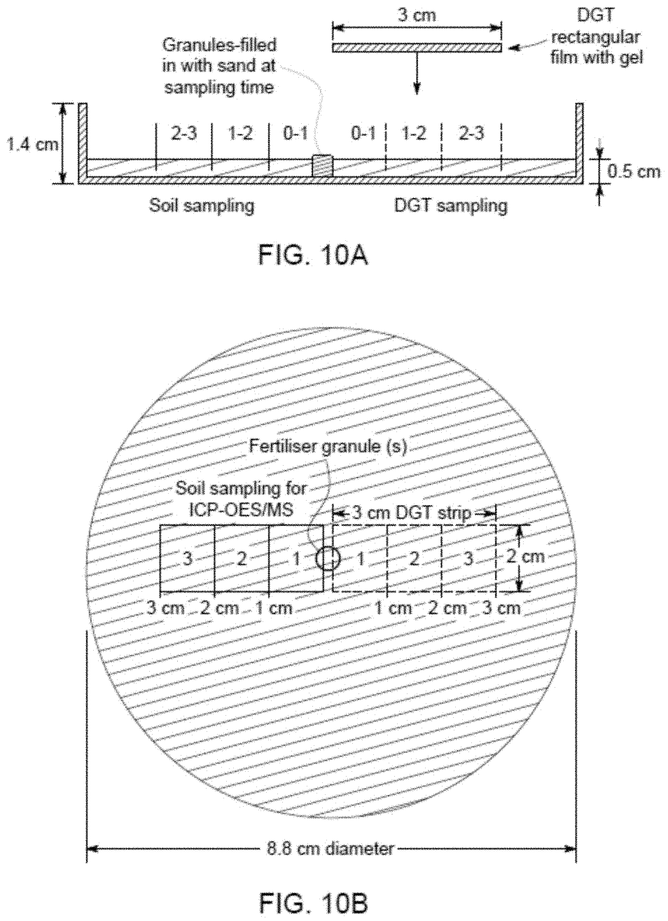

FIG. 10A shows the petri dish system from the side (profile view), and FIG. 10B shows the petri dish from the top. Positions suitable for sampling with the DGT technique are indicated.

At the end of seven days, the soil is analysed in two ways:
1. Soil DTPA extraction and analysis by atomic absorption spectrometry (AAS)—The nutrient diffusion around the LDH is analysed from ˜0.5 g of homogenised soil samples at set distances (0.5, 1.5, 2.5 cm, see FIG. 1). The soil is extracted within 24 hours using a DTPA solution using standard methods for soil, and subsequently analysed by AAS for Zn and Mn concentrations.
2. Diffusive Gradient in Thin films (DGT) with laser ablation and ICP-MS—The soil in the petri dish is wetted to 100% of water holding capacity. A DGT film (approximately 3 cm×2 cm, FIG. 1) is placed on the soil for 24 hours. The DGT is then analysed by laser ablation and subsequently by ICP-MS in three lines along the length of the strip (centre, and approximately one half of the way to the edge of the strip on either side) for Zn, Mn, and P intensity.

Results

Minimal LDH release may occur at high pH soils, and release increases with soil acidity. However, even in the acidic soil the LDH coating may have a stabilising effect on the fertilizer particle, which will delay the reaction of macro and micronutrients with soil, and thus ensure an improved synchrony with plant demand.

### Example 6: Demonstration of Uptake in Barley Plant—Experiments on Sand Growing Media

There is potential for LDH-covered granules to increase plant uptake of Zn in certain conditions. However, fertilizer granules can take many forms. The chemical composition of fertilizer granules may have an effect on the release of LDH.

One key relevant property of fertilizer granules is pH, which may have an effect particularly when added at the same time as Zn micronutrients. In tests in solution, the release of LDH nutrients has been found to be relatively stable at pH 7, and the LDH could only be degraded at a lower pH. Therefore, it has been hypothesised that by adding LDHs in conjunction with ‘acidic’ fertilizers (e.g. AS granules) that the nearby pH becomes significantly lower than the soil around it (due to nitrification). Therefore the LDHs on the fertilizer granule surface become more available to the plant.

As a first demonstration of the efficient release of Zn, Mn and Cu from LDHs to plants, experiments have been developed by using the LDHs alone, without further fertilizer granule addition on sand media.

Materials

Experiments have been performed to test the Zn LDHS (MgFeZnNO₃/MgFeZnNO₃), and Mn LDHS (MgFeMnCO₃/MnAlNO₃). Each experiment compared the plant uptake of Zn or Mn in comparison with control plants were the corresponding metal was not provided.
Plant model: Barley, variety Antonia.
Pots: 160 ml pots containing 220 g of washed quartz sand (density of 1.65 Kg L⁻¹)
Nutrient sources:
   LDH's: 10 mg/plant or pot: MgFeZnNO₃, MgFeZnCO₃; MgMnCO₃, MnAlNO₃. The dose of LDH in each pot was calculated based on the LDH composition, the micronutrient requirements of the plant, expected DW, and finally, the application of 20 times more than the micronutrient quantity resulted (considering a pH controlled nutrient release).
   Nutrient solutions: prepared with Milliq water and containing all essential nutrients except of Zn (NS-Zn) or Mn (NS-Mn). The solutions were provided every day to the pots by irrigation.
Experiments will be carried out in the green-house.

Experimental Procedure
1) Preparation of nutrient sources: 10 mg of LDH were mixed with 80 g (in a 100 ml plastic bottle) of quartz sand shaking for 30 min.
2) Plastic vessels (of 160 ml) were filled up to 2 cm with sand, then with the 80 g homogeneous mixture containing sand and LDH (equivalent with a 1 cm rise), and finally with sand up to 9 cm. Ultrapure water was added to get the 80% of the field capacity in the pot (50 ml).
3) Seeds were humidified for 24 h with ultrapure water: seeds will submerge in water in a beaker in the darkness and continuously aerated. Then, 2 seeds were put in each pot doing a small hole in the sand at the top after their preparation (earlier step). The pots were covered with plastic film to preserve the humidity in the germination period.
4) After 14 days the seedling development were observed and only one seedling was maintained, removing the other one. In this short period it is not expected that roots arrive into the band. Plants grew now without the plastic film.
5) Ultrapure water was added every day to maintain the humidity in the pot by the weighting of them during the first two weeks. After that, nutrient solution was provided according to a plan based on growing rate and plant water and nutrient requirement, increasing the concentration of the nutrient solution over the experiment. When necessary, extra milliq water will be added to achieve the correct weight of the pot.

The duration of the experiments was 11 weeks.

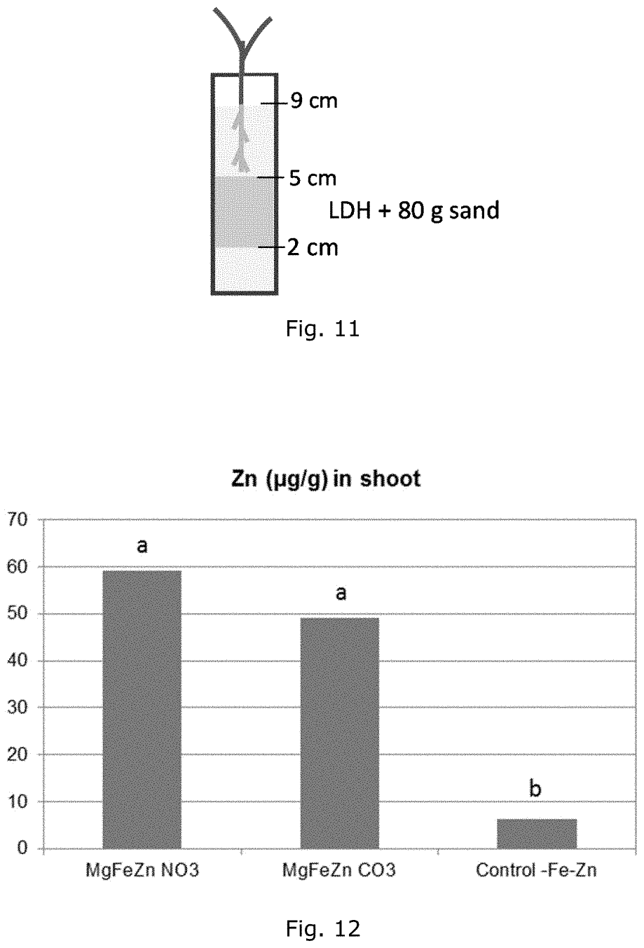

FIG. 11 shows a schematic of the pots in Example 6, the pot content and distribution.

The complete design of the experiment was: 9 treatments (6 LDH's+3 controls)×5 replicates=45 pots.

Sampling and Analysis
1) Photos are taken periodically (and the harvest day) for observing possible differences in the plant development.
2) Shoot part is harvested (the whole parte), washed subsequently with deionized water containing few drops of detergent (Tween 20, Sigma Aldrich), deionized water, twice in Milli-Q water (Millipore, Billerica, Mass., USA), weighted for FW and freeze dried for 72 h and weighted for DW. Samples will be milled for the subsequent analysis for nutrient concentrations by ICP-OMS.
3) The plastic pot is removed carefully and the excess of sand removed shaking for a few seconds. Then, as much as possible sand will be removed from the root by shaking inside a plastic bag. Roots will be cleaned with tap water, to remove all the sand, and the similarly than that done with the shoots with deionized water containing few drops of detergent (Tween 20, Sigma Aldrich), deionized water, twice in Milli-Q water (Millipore, Billerica, Mass., USA), weighted for FW and freeze dried for 72 h and weighted for dry weight. Samples will be milled for the subsequent analysis for nutrient concentrations by ICP-OMS.

Results

FIG. 12 shows Zn concentration in shoots of barley plants grown under sand media with the treatments. Different letters indicate statistical differences according to the Duncan test at P≤0.05.

From FIG. 12 it is seen that the concentration of Zn in plants grown under the Zn LDHs media were higher than plants grown under media without Zn (Control), demonstrating the efficient dissolution of Zn and its subsequent uptake by plants. No differences were observed between the nitrate and carbonate forms of Zn LDHs demonstrating a similar effectiveness.

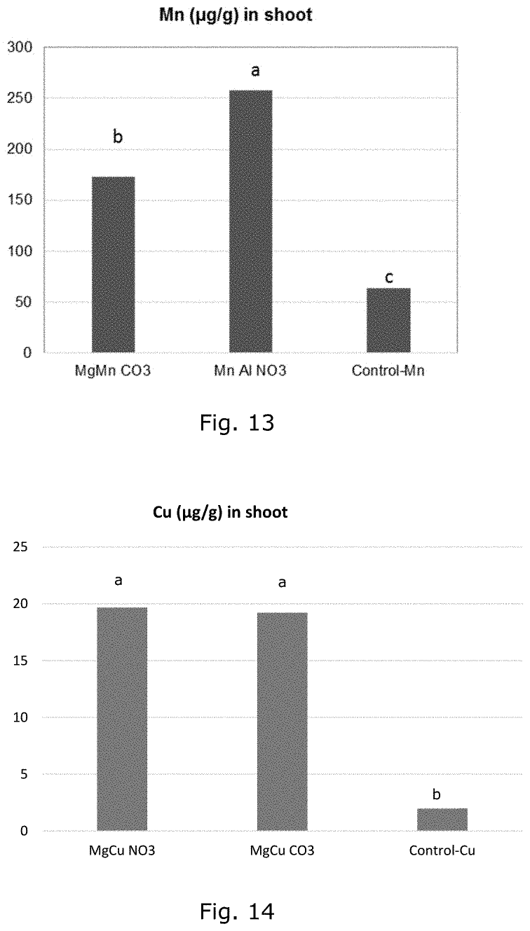

FIG. 13 shows Mn concentration in shoots of barley plants grown under sand media with the treatments. Different letters indicate statistical differences according to the Duncan test at P≤0.05.

FIG. 13 shows similar results obtained when Mn LDHs were studied. In this case, the Mn uptake increased under the MnAlNO₃ LDH as compared to the MgMnCO₃. However, both LDHs provided higher Mn to plants than controls. No significant differences were observed in the concentration of other nutrients.

FIG. 14 shows Cu concentration in shoots of barley plants grown under sand media. Different letters indicate statistical differences among treatments according to the Duncan test at P≤0.05.

Similar tendencies were found for Zn LDHs as for Cu LDHs (comparing FIG. 12 with FIG. 14). The same tendency was than for Zn LDHs was obtained when Cu LDHs were studied (FIG. 14). Both LDHs provided higher Cu to plants than controls.

### Example 7: Demonstration of Uptake in Barley Plant—Experiments on Soil Growing Media

Table 4 shows an overview of the experiments with composites comprising LDH with Mn.

TABLE 4
LDH comprising Mn experiment s

| | Fertilizer granules | Treatment |
|---|---|---|
| Fertilizer granules | covered by | name |
| DCODER granules | Oil alone | DC |
| | MnSO₄ | DC + MnSO₄ |
| | MnEDTA | DC + MnEDTA |
| | LDH-Mn: MgMnCO₃ | DC − |
| | | LDHn Mn |
| | LDH-Mn: MnAINO₃ | DC − |
| | | LDHc − Mn |
| Total treatments + | 5 | |
| controls | | |
| Replicates and total | 5 | 25 |

Table 5 shows an overview of the experiments with composites comprising LDH with Zn.

TABLE 5
LDH comprising Zn experiments

| Fertilizer granules | Fertilizer granules covered by | Treatment name |
|---|---|---|
| AS granules | Oil alone | AS |
| | ZnEDTA | AS + ZnEDTA |
| | LDH-Zn: MgZnFeNO₃ | AS − LDHn − Zn |
| | LDH-Zn: MgZnFeCO₃ | AS − LDHc − Zn |
| CN granules | Just Timac Agro-provided oil | CN |
| | ZnEDTA | CN + ZnEDTA |
| | LDH-Zn: MgZnFeNO₃ | CN − LDHn − Zn |
| | LDH-Zn: MgZnFeCO₃ | CN − LDHc − Zn |
| AS granules | Oil alone | AS DCD |
| with DCD | Zn EDTA | AS DCD + ZnEDTA |
| | LDH-Zn: MgZnFeNO₃ | AS DCD − LDHn − Zn |
| | LDH-Zn: MgZnFeCO₃ | AS DCD − LDHc − Zn |
| DCODER | Oil alone | DC |
| granules | Zn EDTA | DC + ZnEDTA |
| | LDH-Zn: MgZnFeNO₃ | DC − LDHn − Zn |
| | LDH-Zn: MgZnFeCO₃ | DC − LDHc − Zn |
| Total treatments + | 16 | |
| controls | | |
| Replicates | 5 | 80 |
| and total | | |

Fertilizer Granule Preparation

Fertilizer granules—Three separate treatments of fertilizers are used, all at a rate of 100 mg N per plant, i.e. 400 mg N per pot. The N-based fertilizer granules have a diameter of 1-2 mm: 1. AS granules, 2. CN granules, 3. AS granules+nitrification inhibitor (DCD), while 4. the DCODER granules have a diameter of 2.5 mm. Table 6 show the fertilizer products that are used, and Table 4 shows the quantities required for each treatment. In total, 1.96 g of AS, 2.60 g of CN, and 2.00 g DCODER is needed per pot to meet the N addition target.

Talcum powder—talcum powder (Mg₃Si₄O₁₀(OH)₂) is added to the surface of the granules to ensure that all treatments have the same powder covering (32 mg/g of fertilizer).

Uncoated controls—Control pots receive only ammonium granules (AS), calcium nitrate granules (CN), or AS granules with nitrification inhibitor (AS DCD). The fertilizer controls are covered with Timac Agro-provided oil and talcum powder.

Positive controls—Fertilizer granules covered in Timac Agro-provided oil and MnSO₄, MnEDTA, or ZnEDTA. The equivalent of 0.5 mg Zn, or 1 mg Mn is applied per plant within the granules.

LDH treatments—The fertilizer granules are covered in Timac Agro-provided oil and LDH in the lab in Copenhagen. The granules are coated to the equivalent of adding 0.5 mg Zn, or 1 mg Mn per plant. For the Zn experiment, MgFeZnNO₃ and MgFeZnCO₂ LDHs are used. For the Mn experiment, MgMnCO₃ and MnAlNO₃ are used.

Nitrification inhibitor—DCD is used in addition for ⅓^{rd} of the treatments (only covering AS granules), added at a rate of 7 mg DCD-N per plant, or 6.5% of total of added with the fertilizer.

Fertilizer coating—Fertilizers are coated as described in Example 2.

Soil Preparation

Pots are filled with 1.5 Kg of a substrate containing a sandy soil from Sweden (Kristianstad) mixed with 40% v/v Leca, 20% v/v perlite, and 0.1% (m/m) CaCO₃, pH 7.5. The additions are mixed into the soil to create porous and alkaline soil conditions that induce Mn deficiency. The soil is pressed to a consistent bulk density.

Fertilizer Addition to Soil—Fertilizer Amounts and Positions

100 mg N is added per plant (i.e. 400 mg per pot). In total, 1.96 g of AS, 2.60 g of CN, and 2.00 g DCODER is needed per pot to meet the N addition target. The amount of LDH/positive control is equivalent to 0.5 mg Zn and 1.0 mg Mn per plant for the relevant treatments. Talc is used to cover the granules at a rate of 32 mg/g, derived from the treatment with the maximum powder coating before talc is considered. In the pots, the fertilizer granules are placed in four equidistant locations around the pot. The granules are then covered with 650 g of soil.

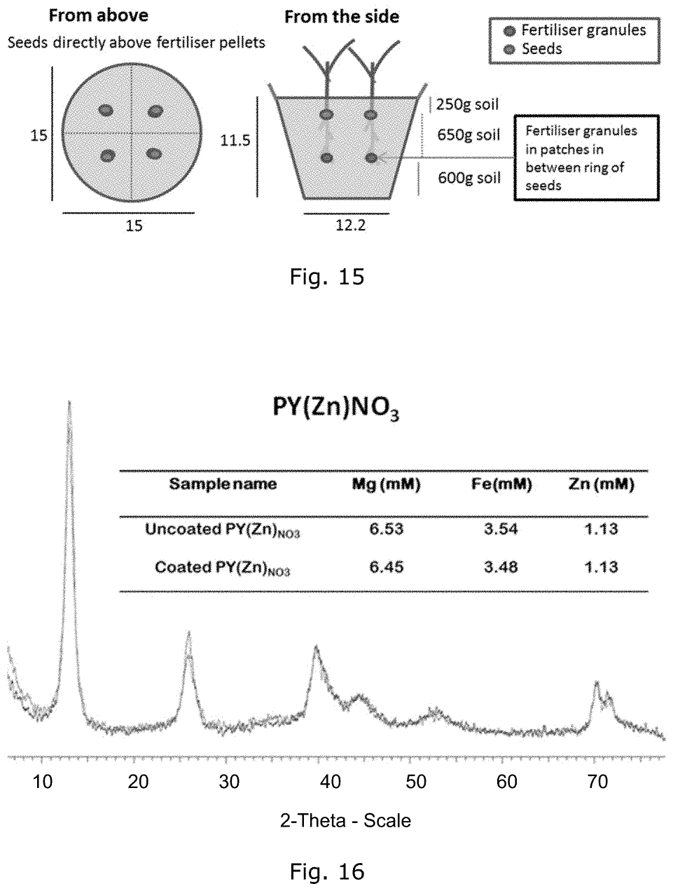

FIG. 15 shows the position of the seeds and fertilizer in the 2 l pots of Example 7. All numbers are distances in cm.

Table 6 shows the weight of soil and nutrient solution added to the pots.

TABLE 6

| | Weight (g) |
|---|---|
| +plastic pot | 50 |
| +600 g soil and push | 650 |
| +treatments in 4 | |
| places | |
| +650 g soil and push | 1300 |
| +8 seeds | |
| +250 g soil and push | 1550 |
| +250 ml nutrient | 1800 |
| solution | |

Seed Preparation and Planting

Barley is grown (variety—Antonia). Eight seeds (per pot) are germinated separately in vermiculite for 48 hours (It is assumed that 50% of the seeds will not germinate). From the vermiculite, four strongly germinating seeds are chosen for each pot. Barley seedlings are transferred into pots filled with soil mixture in the positions described above. After addition of the germinated seeds, the pot soil is maintained moist for another 48 hours before reducing the moisture content to the target level (15%, see below).

Nutrient Solution

After the soil, fertilizer and seeds are in the pot, nutrient solution is added to the soil to ensure adequate macronutrients. 250 ml of the solutions (mixed with double distilled water) is used. Table 7 shows the contents of the nutrient solutions used.

TABLE 7

| Experiment and | |
|---|---|
| fertilizer granules | Solution nutrient contents |
| AS or CN granules | 800 μM CaSO₄•2H₂O, 100 μM |
| (Zn experiment). | Ca(H₂PO₄)2•H₂O, 300 μM MgSO₄, |
| Lack P, K, Ca, Mg, Na. | 600 μM K₂SO₄, 100 μM NaCl |
| DCODER granules | 900 μM CaSO₄•2H₂O, |
| (Mn and Zn experiment). | 100 μM NaCl |
| Lack of Ca, Na. | |

The soil after that is very wet. For the next three days, the soil is maintained at 1,750 g to ensure adequate moisture for the continued germination of the seeds, before being subsequently reduced to 15% gravimetric moisture content (see below).

Growth Conditions and Moisture Control

The plants are placed in growth chambers, which are maintained in a 16h day/8h night cycle at 20/18° C. (humidity is not specifically controlled). The pots are weighed frequently over the course of the experiment, and double-distilled water added from above, to maintain the water content at 15% gravimetric moisture content. The amount of added water is adapted over the experiment according to the increase in plant weight. Pre-tests have shown that about 50 ml of water is lost per day in these growth conditions.

The plants are monitored for signs of nutrient deficiency, and additional nutrients (N, P or K) are added as a diluted nutrient solution after 2-3 weeks and every week thereafter if necessary (possibly using the same chemical formulation as described earlier for the solution described above).

Sampling and Analysis

Photos are taken periodically (every 14 days, and on the harvest day) to observe differences in plant development.

Shoot Harvesting

Plants are sampled twice: after 21 days for the shoot of one plant in each pot and after 42 days for the final harvest of everything else (the exact day depends on the plant size and health at the time). The shoots are harvested (the whole part), washed with deionised water containing a few drops of detergent (Tween 20, Sigma Aldrich), then deionised water alone, and then twice in Milli-Q water (Millipore, Billerica, Mass., USA). After covering briefly in kitchen towel, the shoots are weighed for fresh weight, freeze-dried for 72 h and weighed for dry weight. Samples are milled for subsequent analysis of nutrient concentrations by ICP-OES.

Soil Samples

Soil micronutrient contents are analysed from a homogenised sample of the whole pot using the DTPA method (see below). Bulk soil pH is also analysed before the seeds are planted, and after the plants are harvested.

Also, the pH of the soil without any fertilizer addition, and within 5 cm of the fertilizer granules after addition is tested separately to the pot experiment. Soil pH is analysed by adding 25 ml of water to 10 g of soil in a falcon tube and manually stirring. Samples are left for 30 min. The suspension is stirred well just before immersing the electrode.

DTPA Method for Determination of Soil Zn, Mn and Other Micronutrients

The following is performed on a bulked and homogenised soil sample from each pot. Zn, and Mn concentrations are analysed by the DTPA method (10 g and 20 g, respectively, the Falcon tubes collecting the 20 g should be pre-weighed). Fe and Cu concentrations can also be analysed to look at the Fe/Mn molar ratio and the Zn/Cu ratio in the plants.

40 ml of DTPA extracting solution (Lindsay and Norwel, pH 7.3) is added to the 20 g of soil in the Falcon tube and agitated for 1 h. Samples are centrifuged (9,000 rpm for 5 min) and the solution filtered with Whatman filter paper. Samples are collected and acidified for subsequent analysis by AAS (10 ml sample+2 ml 1 M HCl).

Results

Barley plants with micronutrient contents within the micronutrient sufficiency ranges are obtained.

### Example 8: How to Make the LDH

Methods for making MgMnCO₃ LDH are described in Hansen & Taylor, 1991 (Clay Minerals, vol 26: 507-525) [3].

The nitrate form of Zn doped Mg—Fe(III) LDH namely PY(Zn)_{NO3} can be prepared by a constant pH co-precipitation method (Miyata et al., 1975) [4]. An aqueous solution of Fe(NO₃)₃.9H₂O is added drop wise to a mixed solution of Mg(NO₃)₂.6H₂O and Zn(NO₃)₂[Zn/(Zn+Mg+Fe)=0.05] with constant magnetic stirring (PTFE oval magnetic spinning bar, 25×12 mm, 600 rpm) overnight at room temperature. During the metal ion addition, the pH of the reaction mixture is maintained at 9.5±0.2 using a ‘Metrohm 719S’ Titrino by automatic addition of a freshly prepared carbonate free 1.0 M NaOH solution. A ‘Metrohm 6.0262.100 pH 0-13/0-80° C.’ electrode was used which is calibrated with pH buffers 4.0 and 7.0. The mixture solution is constantly kept under a flow of argon (Ar) gas to hinder access of CO₂ and hence, to avoid contamination with carbonate. Finally, the precipitate is centrifuged (2860 g), washed three times with water-ethanol (50%-EtOH) mixture and dried overnight in an oven at 65° C.

The undoped Mg—Fe(III) LDH namely PY_{NO3} is synthesized by drop wise adding a 0.1 mol/L solution of Fe(NO₃)₃ to a 0.2 mol/L solution of Mg(NO₃)₂ (molar ratio Mg/Fe=2) and maintained at a constant pH of 9.5±0.2, as described above. The corresponding carbonate form (PY_{CO3}) is obtained by ion exchange of the PY_{NO3}; 1.0 g of PY_{NO3} is dispersed in 100 mL of 0.1 mol/L Na₂CO₃ solution for 3 h, followed by centrifugation and washing as described above.

### Example 9: Coating of Fertiliser Particles with LDH Particles

The procedure is a downscaling of standard factory procedures, and thus reflects a well-known industrial fertiliser coating process.

Equipment Needed
A controllable, rotating stainless steel drum
Pipette (100-1000 μl)
Weighing scale with precision to milligrams
Timac Agro-provided oil
LDH powder
Talcum powder
AS, CN or NPK granules
A small metal spoon

Procedure
1) Weigh 30g of N fertiliser pellets (sieved to a consistent size. For the AS and CN granules, between 1 and 2 mm).
2) Angle the rotating drum slightly backwards (˜20 degrees from vertical?).
3) Weigh the required amount of LDH, positive control powder (calculated from the main experiment protocol), DCD and talcum powder as required.
4) Mix the powders together in another container.
5) Pour the pellets into the drum. Turn on the rotation and set the speed to at least 8.
6) Pipette the Timac Agro-provided oil (˜16 μl per g fertiliser) and slowly add it, drop by drop, over the fertiliser pellets. From testing, it seems better if you add half of this to the granules, then add some powder, and then add the rest of the oil. If the pellets start to stick to the side of the drum during the process, you have added too much oil; you should add some powder to dislodge it.
7) Use a plastic spoon/spatula/weighing container to add the powder to the pellets bit by bit. Once most is added, you can add the powder directly from the container.
8) You can use a plastic weighing container to dislodge any oil/pellets that have become stuck to the rotating drum.
9) Only prepare one treatment at a time; in between you need to clean and dry the drum following step 9 below.
10) Place the coated fertilisers in a container where they can spread out in a thin layer, and leave for at least 15 minutes (to dry a little). At the end, put the fertilisers in a plastic bag.
11) Use only water and kitchen roll to wash and wipe the stainless steel drum. Wait until the drum is completely dry before trying to coat any more fertilisers.

### Example 10: Demonstration of Release to the Soil

Layered double hydroxides (LDHs) are synthetic materials containing metals such as Zn, Cu and Mn that are stable at pH greater than 7, but slowly release the metals at lower pH. The purpose of this experiment is to test the effect of the pH on the LDH diffusion in the soil. LDHs will be added to three soils of varying acidity: acid (5.5), neutral (7.0), and alkaline (8.0). We expect to observe minimal LDH release at high pH soils, increasing with soil acidity. Even in the acidic soil we expect that the LDH coating will have a stabilising effect on the fertiliser particle, which will delay the reaction of macro and micronutrients with soil, and thus ensure an improved synchrony with plant demand.

Zinc (Zn) and Manganese (Mn) LDHs are coated on several different fertilisers (the D-CODER RCF 7-10-6, ammonium sulphate, and calcium nitrate fertilisers). A small amount of fertiliser granule (0.1g) is placed in the centre of a petri dish.

Three different soils of pH 5.5, 7 and 8 are used. The different soils have different soil characteristics affecting diffusion such as water holding capacity (WHC), texture, organic matter content, tortuosity and others. To reduce the problem of soil heterogeneity, the soils will be sieved to 2 mm.

The soil is wetted to 60% WHC and incubated for 7 days at 22/18° C. (day/night) in the growth chamber. After 7 days, a DGT strip is placed on the soil for 24 hours to collect phosphorous and zinc/manganese from an area 3×2 cm, afterwards analysed by laser ablation or split into three pieces (centred at 0.5, 1.5, and 2.5 cm from the fertiliser granules) and analysed with ICP-OES/MS. On the opposite side of the petri dish, soil is analysed at three locations 0.5, 1.5, and 2.5 cm and analysed for P, Zn/Mn after digestion and ICP-OES/MS analysis.

Materials

LDH: controlled-release fertiliser containing Zn (MgFeZnNO₃), or Mn (MnAlNO₃). Fertiliser granules: NPK granules from Navarra (D-CODER 7-10-6, ammonium sulphate granules from Swedane and calcium nitrate granules from Yara Incubation systems: Plastic petri dishes (diameter 8.8 cm, height 1.4 cm).

Soils:
1. Unfertilised soil from the nutrient depletion trial plot B1 (pH ˜5.5, no P received, 60 kg ha⁻¹ N and K, 25 kg ha⁻¹ S)
2. Unfertilised soil from CRUCIAL experiment (plot B5, pH ˜7).
3. Spanish soil (Valencia) from Sandra (pH ˜8.0)

The properties of these soils are presented below:

TABLE 8
Properties of the three soils used
in the soil release experiment

| | Nut. Dep. | CRUCIAL | Spanish soil |
|---|---|---|---|
| | Trial B1 | unfertilised | Valencia |
| Soil treatment | treatment | (B5) | (Moncada) |
| pH | 5.5 | 7.0 | 8.0 |
| P analysis | Olsen P | Olsen P | ? |
| method | | | |
| P content | 11 | 13-15 | ? |
| (mg kg⁻¹) | | | |
| Zn content | 45.0 | 1.7 | 6.3 |
| (mg kg⁻¹) | | | |
| Mn content | ? | 7.5 | 39.0 |
| (mg kg⁻¹) | | | |
| Total C (%) | 1.2 | 1.4 | ? |
| Total N (%) | 0.13 | 0.13 | 0.14 |
| Sand (%) | 65 | 65 | 60 |
| Silt (%) | 18 | 16 | 24 |
| Clay (%) | 15 | 16 | 16 |

Experimental Method

Three air-dried soils of differing pH (5.5-7-8) are sieved to 2 mm. A petri dish (diameter 8.8 cm, height 1.4 cm) is filled with of soil to a height of 0.5 cm, packed at a density of 1.3 g cm⁻³ and wetted to 60% WHC¹ by dripping water onto the soil. The dishes are covered (e.g. with a plastic cap), and left to equilibrate overnight. A small amount (0.1 g or more) of fertiliser granules (RCF granules from Navarra, ammonium sulphate, and calcium nitrate) is placed in the centre of the petri dish. The granules are covered in a Zn or Mn LDH product as shown in Table 9 below.

TABLE 9
The amount of LDH covering the granules and
the amount of target element released to soil

| | | | | Zn or Mn from |
|---|---|---|---|---|
| | Weight | | | fertiliser |
| | Zn or Mn | Weight of | | expected in DOT |
| | (% of | granules | Zn or Mn | or DTPA |
| | granule | added to soil | added to | sampling area* |
| Product | weight) | (g) | soil (ng) | (ng) |
| NPK 7-10-6 | 0.05% | 0.1 | 50 | 20 |
| MgZnFeNO₃ | | | | |
| NPK 7-10-6 | 0.19% | 0.1 | 190 | 76 |
| MgMnCO₃ | | | | |
| NPK 7-10-6 | 0.29% | 0.1 | 290 | 116 |
| MnAINO₃ | | | | |
| AS MgZnFeNO₃ | 0.11% | 0.1 | 105 | 42 |
| AS MnAINO₃ | 0.21% | 0.1 | 210 | 84 |
| CN MgZnFeNO₃ | 0.08% | 0.1 | 77.5 | 31 |
| CN MnAINO₃ | 0.16% | 0.1 | 155 | 62 |

*Assumed to be 40% of total because DGT sheet is placed to one side of fertiliser pellet

The granules are placed at the centre of the petri dish. The petri dishes are incubated for 7 days or more in controlled temperature conditions (22/18° C., day/night) in a growth chamber or in the basement. On the seventh day (or later), the granules are removed and replaced with sand.

At the end of seven days, the soil is analysed in two ways:
1. Soil digestion and analysis ICP-OES/MS—The nutrient diffusion around the LDH is analysed from ˜3 g of homogenised soil samples (1×2×0.5 cm) at set distances (0.5, 1.5, 2.5 cm in FIG. 1) digestion, and subsequent analysis by ICP-MS/OES (analysis of P and LDHs simultaneously). The soil is digested within 24 hours.
2. DGT analysis with laser ablation or ICP-OES/MS—The fertiliser granules are removed on day 7. The hole left behind is replaced with sand (the standard sand we use). The soil in the petri dish is wetted to 100% of water holding capacity. The DGT system (3 cm×2 cm, FIG. 1) is placed on the soil for 24 hours. The DGT is then analysed by one of two methods, depending on if the laser ablation system is available:
   a. Laser ablation of the entire DGT strip. The whole strip is analysed to give a 2D image of the distribution of P and LDH through the soil.
   b. ICP-OES/MS analysis of digestions from three, 1×2 cm portions of the DGT strip centred at positions 0.5, 1.5, and 2.5 cm from the fertiliser granules for P and LDH.

### Example 11: Demonstration of Uptake in Plant

Experimental Design and Method

There is potential for LDH-covered granules to increase plant uptake of Zn in certain conditions. However, fertiliser granules can take many forms. The chemical composition of fertiliser granules may have an effect on the release of LDH.

One key relevant property of fertiliser granules is pH, which may have an effect particularly when added at the same time as Zn micronutrients. In tests in solution, the release of LDH nutrients has been found to be relatively stable at pH 7, and the LDH could only be degraded at a lower pH. Therefore, it has been hypothesised that by adding LDHs in conjunction with ‘acidic’ fertilisers (e.g. AS granules) that the nearby pH becomes significantly lower than the soil around it (due to nitrification). Therefore the LDHs on the fertiliser granule surface become more available to the plant.

Table 10 and Table 11 show a summary of the treatments used in the experiments:

TABLE 10
Treatments for the Mn LDH experiment

| Mn Experiment | Fertiliser granules | |
|---|---|---|
| Fertiliser granules | covered by | Treatment name |
| | Oil alone | DC |
| | MnSO₄ | DC + MnSO₄ |
| DCODER granules | MnEDTA | DC + MnEDTA |
| | LDH-Mn: MgMnCO₃ | DC − LDHn − Mn |
| | LDH-Mn: MnAINO₃ | DC − LDHc − Mn |
| Total treatments + controls | 5 | |
| Replicates and total | 5 | 25 |

TABLE 11
Treatments for the Zn LDH experiment

| Zn Experiment | Fertiliser granules | |
|---|---|---|
| Fertiliser granules | covered by | Treatment name |
| | Oil alone | AS |
| AS granules | ZnEDTA | AS + ZnEDTA |
| | LDH-Zn: MgZnFeNO₃ | AS − LDHn − Zn |
| | LDH-Zn: MgZnFeCO₃ | AS − LDHc − Zn |
| | Just Timac | CN |
| | Agro-provided oil | |
| CN granules | ZnEDTA | CN + ZnEDTA |
| | LDH-Zn: MgZnFeNO₃ | CN − LDHn − Zn |
| | LDH-Zn: MgZnFeCO₃ | CN − LDHc − Zn |
| | Oil alone | AS DCD |
| AS granules | ZnEDTA | AS DCD + ZnEDTA |
| with DCD | LDH-Zn: MgZnFeNO₃ | AS DCD − LDHn − Zn |
| | LDH-Zn: MgZnFeCO₃ | AS DCD − LDHc − Zn |
| DCODER | Oil alone | DC |
| granules | ZnEDTA | DC + ZnEDTA |
| | LDH-Zn: MgZnFeNO₃ | DC − LDHn − Zn |
| | LDH-Zn: MgZnFeCO₃ | DC − LDHc − Zn |
| Total treat- | 16 | |
| ments + controls | | |
| Replicates | 5 | 80 |
| and total | | |

Fertiliser Granule Preparation

Fertiliser granules—Three separate treatments of fertilisers are used, all at a rate of 100 mg N per plant, i.e. 400 mg N per pot. The N-based fertiliser granules have a diameter of 1-2 mm: 1. AS granules, 2. CN granules, 3. AS granules+nitrification inhibitor (DCD), while 4. (the DCODER granules) have a diameter of 2.5 mm. In total, 1.96 g of AS, 2.60 g of CN, and 2.00 g DCODER is needed per pot to meet the N addition target.

Talcum powder—talcum powder (Mg₃Si₄O₁₀(OH)₂) is added to the surface of the granules to ensure that all treatments have the same powder covering (32 mg/g of fertiliser).

Uncoated controls—Control pots receive only ammonium granules (AS), calcium nitrate granules (CN), or AS granules with nitrification inhibitor (AS DCD). The fertiliser controls are covered with Timac Agro-provided oil and talcum powder.

Positive controls—Fertiliser granules covered in Timac Agro-provided oil and MnSO₄, MnEDTA, or ZnEDTA. The equivalent of 0.5 mg Zn, or 1 mg Mn is applied per plant (Table 11) within the granules.

LDH treatments—The fertiliser granules are covered in Timac Agro-provided oil and LDH in the lab in Copenhagen. The granules are coated to the equivalent of adding 0.5 mg Zn, or 1 mg Mn per plant (Table 10). For the Zn experiment, MgFeZnNO₃ and MgFeZnCO₂ LDHs are used (the newly-made 2×concentration Zn LDH). For the Mn experiment, MgMnCO₃ and MnAlNO₃ are used.

Nitrification inhibitor—DCD is used in addition for ⅓^{rd} of the treatments (only covering AS granules), added at a rate of 7 mg DCD-N per plant, or 6.5% of total of added with the fertiliser.

Fertiliser coating—Fertilisers are coated as described in Example 9.

Soil Preparation

Pots are filled with 1.5 Kg of a substrate containing a sandy soil from Sweden (Kristianstad) mixed with 40% v/v leca, 20% v/v perlite, and 0.1% (m/m) CaCO₃, pH 7.5. The additions are mixed into the soil to create porous and alkaline soil conditions that induce Mn deficiency. The soil is pressed to a consistent bulk density.

Fertiliser Addition

Fertiliser Amounts and Positions

100 mg N is added per plant (i.e. 400 mg per pot). In total, 1.96 g of AS, 2.60 g of CN, and 2.00 g DCODER is needed per pot to meet the N addition target. The amount of LDH/positive control is equivalent to 0.5 mg Zn and 1.0 mg Mn per plant for the relevant treatments. Talc is used to cover the pellets at a rate of 32 mg/g, derived from the treatment with the maximum powder coating before talc is considered. In the pots, the fertiliser granules are placed in four equidistant locations around the pot (FIG. 15). The granules are then covered with 650g of soil (FIG. 15).

TABLE 12
The weight of soil and nutrient solution added to the pots

| | Weight (g) |
|---|---|
| +plastic pot | 50 |
| +600 g soil and push | 650 |
| +treatments in 4 | |
| places | |
| +650 g soil and push | 1300 |
| +8 seeds | |
| +250 g soil and push | 1550 |
| +250 ml nutrient | 1800 |
| solution | |

Seed Preparation and Planting

Barley is grown (variety—Antonia). Eight seeds (per pot) are germinated separately in vermiculite for 48 hours (It is assumed that 50% of the seeds will not germinate). From the vermiculite, four strongly germinating seeds are chosen for each pot. Barley seedlings are transferred into pots filled with soil mixture in the positions described above (Table 12, FIG. 15). After addition of the germinated seeds, the pot soil is maintained moist for another 48 hours before reducing the moisture content to the target level (15%, see below).

Nutrient Solution

After the soil, fertiliser and seeds are in the pot, nutrient solution is added to the soil to ensure adequate macronutrients. 250 ml of the following solution (mixed with double distilled water) is used:

TABLE 13
Nutrient solution.

| Experiment and | |
|---|---|
| fertiliser granules | Solution nutrient contents |
| AS or CN granules | 800 μM CaSO₄•2H₂O, |
| (Zn experiment). | 100 μM Ca(H₂PO₄)2•H₂O, |
| Lack P, K, Ca, Mg, Na. | 300 μM MgSO₄, 600 μM |
| | K₂SO₄, 100 μM NaCl |
| DCODER granules | 900 μM CaSO₄•2H₂O, |
| (Mn and Zn | 100 μM NaCl |
| experiment). | |
| Lack of Ca, Na. | |

Further details about the contents of the nutrient solution and the amount of each chemical required are presented in the Table. The soil after that is very wet. For the next three days, the soil is maintained at 1,750 g to ensure adequate moisture for the continued germination of the seeds, before being subsequently reduced to 15% gravimetric moisture content (see below).

Growth Conditions and Moisture Control

The plants are placed in growth chambers, which are maintained in a 16h day/8h night cycle at 20/18° C. (Schmidt, S. B., Pedas, P., Laursen, K. H., Schjoerring, J. K., Husted, S., 2013. Latent manganese deficiency in barley can be diagnosed and remediated on the basis of chlorophyll a fluorescence measurements. Plant and Soil 372, 417-429. doi:10.1007/s11104-013-1702-4) [5] (humidity is not specifically controlled). The pots are weighed frequently over the course of the experiment, and double-distilled water added from above, to maintain the water content at 15% gravimetric moisture content (advised by Lizhi and Pai). The amount of added water is adapted over the experiment according to the increase in plant weight. Pre-tests have shown that about 50 ml of water is lost per day in these growth conditions.

The plants are monitored for signs of nutrient deficiency, and additional nutrients (N, P or K) are added as a diluted nutrient solution after 2-3 weeks and every week thereafter if necessary (possibly using the same chemical formulation as described earlier for the solution described above).

Sampling and Analysis

Photos

Photos are taken periodically (every 14 days, and on the harvest day) to observe differences in plant development.

Shoot Harvesting

Plants are sampled twice: after 21 days for the shoot of one plant in each pot and after 42 days for the final harvest of everything else (the exact day depends on the plant size and health at the time). The shoots are harvested (the whole part), washed with deionised water containing a few drops of detergent (Tween 20, Sigma Aldrich), then deionised water alone, and then twice in Milli-Q water (Millipore, Billerica, Mass., USA). After covering briefly in kitchen towel, the shoots are weighed for fresh weight, freeze-dried for 72 h and weighed for dry weight. Samples are milled for subsequent analysis of nutrient concentrations by ICP-OES.

Soil Samples

Soil micronutrient contents are analysed from a homogenised sample of the whole pot using the DTPA method (see below). Bulk soil pH is also analysed before the seeds are planted, and after the plants are harvested.

Also, the pH of the soil without any fertiliser addition, and within 5 cm of the fertiliser pellets after addition is tested separately to the pot experiment. Soil pH is analysed by adding 25 ml of water to 10 g of soil in a falcon tube and manually stirring. Samples are left for 30 min. The suspension is stirred well just before immersing the electrode.

DTPA Method for Determination of Soil Zn, Mn and Other Micronutrients

The following is performed on a bulked and homogenised soil sample from each pot. Zn, and Mn concentrations are analysed by the DTPA method (10 g and 20 g, respectively, the Falcon tubes collecting the 20 g should be pre-weighed). Fe and Cu concentrations can also be analysed to look at the Fe/Mn molar ratio and the Zn/Cu ratio in the plants.

40 ml of DTPA extracting solution (Lindsay and Norwel, pH 7.3) is added to the 20 g of soil in the Falcon tube and agitated for 1 h. Samples are centrifuged (9,000 rpm for 5 min) and the solution filtered with Whatman filter paper. Samples are collected and acidified for subsequent analysis by AAS (10 ml sample+2 ml 1 M HCl).

### Example 12: LDH Particles Coated with Silica

LDHs of the types: zinc-doped pyroaurite [PY(Zn)NO₃] and Mn(II)Al—NO₃ were prepared by the co-precipitation method as described in Examples 1 or 8.

The synthesized LDH powder was surface modified with silica by the seeded polymerization method. After dispersing 1.0 g LDH powder in the mixed solution of 2.33 ml TEOS and 58.38 ml ethanol, predetermined amounts of water (72 ml) and 1.87 ml ammonia (29 wt %) aqueous solutions were added stepwise. The reaction time and temperature were 45 min and 40° C., respectively. The slurry was filtered, washed and dried.

For comparison, comparative samples without silica coating were also prepared.

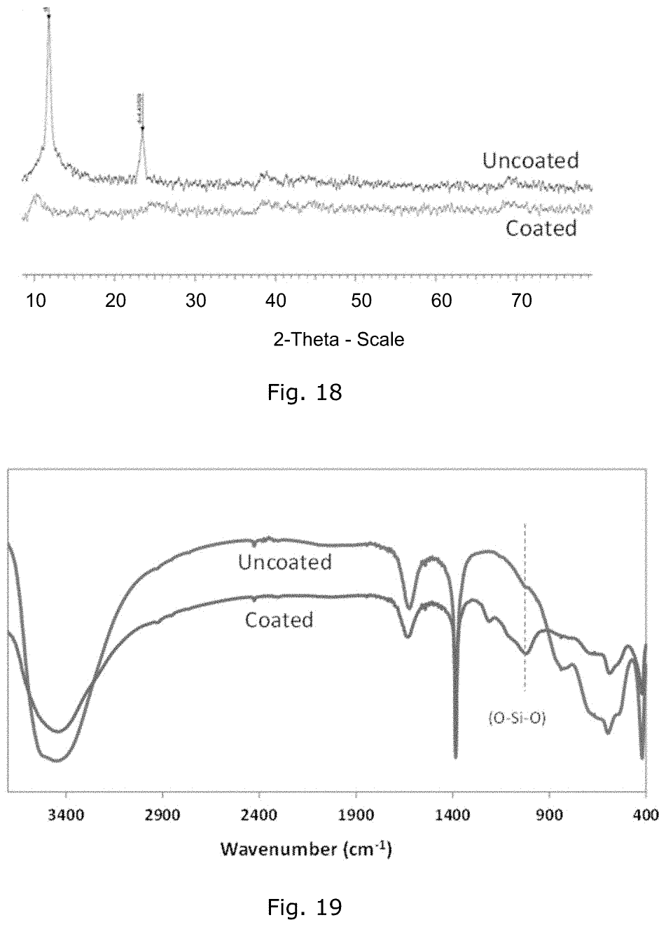

The samples were characterized using X-ray diffraction (XRD). The results are shown in FIG. 16 for the PY(Zn)NO₃ LDH with and without silica coating, and FIG. 18 for the MnAl—NO₃ LDH with and without silica coating. Lamellar structure of LDH core remains normally unchanged upon coating which can be confirmed by the diffraction patterns. Powder XRD patterns for the pristine LDHs and surface modified forms will be recorded using a Siemens D5000 diffractometer applying monochromated Co-Kα (A=0.179021 nm) radiation and with the instrument operated at 40 kV and 40 mA. Randomly oriented powder samples is scanned from 5 to 70° 2θ using steps of 0.02° 2θ and a counting time of 2 sec per step.

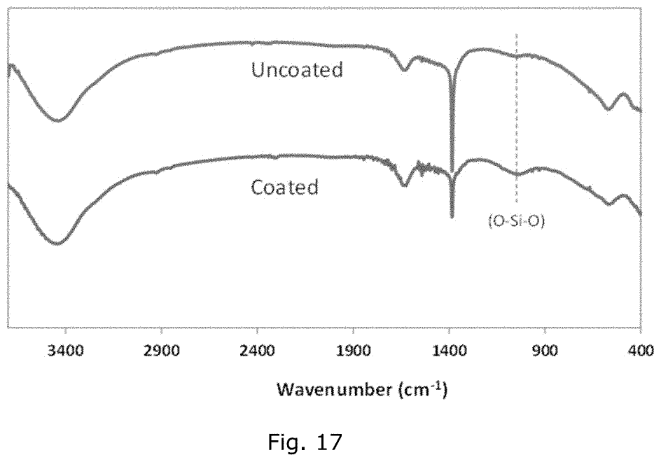

The coated samples were further characterized by Fourier Transform-Infra Red spectroscopic analyses (FT-IR). The results are shown in FIG. 17 for the PY(Zn)NO₃ LDH with and without silica coating, and FIG. 19 for the MnAl—NO₃ LDH with and without silica coating. The silica coating on the surface of the LDH proceeds through the formation of M-O—Si bonds (M=Mg, Fe, Mn) from the reaction of Si(OH)₄ species with hydroxyl groups on the surface of the LDHs particles. FTIR spectra will be collected using a Perkin Elmer L1250230-E spectrometer and pressed pellets (diameter-13 mm) containing approximately 0.35 mg sample and 300 mg KBr. Each FTIR spectrum would be recorded as an average of 10 scans in the range of 400-4000 cm⁻¹ with a resolution of 4 cm⁻¹.

It can be observed from the results of XRD that X-ray diffraction pattern of the coated PY(Zn)_{NO3} sample was overlapped on the pattern of the uncoated sample, which implies that silica-coating reaction occur upon the surface of LDH particles without any reconstruction of the lamellar structure of the hydroxide layers. Uneven baseline in Mn-containing, coated LDHs indicates the presence of a large number of amorphous Si(OH)₄ or SiO₂ species. In FT-IR spectra, the absorption peak at 1085 cm⁻¹, and 500 cm⁻¹, corresponding to Si—O—Si asymmetric stretching and bending mode, respectively, appear after silica coating, revealing the precipitation of SiO₂ on the surface of LDH particles. This result further confirms that the SiO₂ thin film has been successfully coated on the surface of the LDHs used in the study.

The acid dissolution of coated and uncoated LDH samples was monitored at constant pH by using an automatic titrator (‘Metrohm 719S’ Titrino) and temperature control. A 0.1 M HCl solution would be added to LDH dispersion in water over the experiment at constant pH regime of 4.0, 5.0, and 6.0 (±0.2). At appropriate time intervals, aliquots of the suspension were taken and filtered and acidified to conserve the samples for later determination of metal ions by AAS. Suppression in release of metals can be monitored by comparison with the release from uncoated samples.

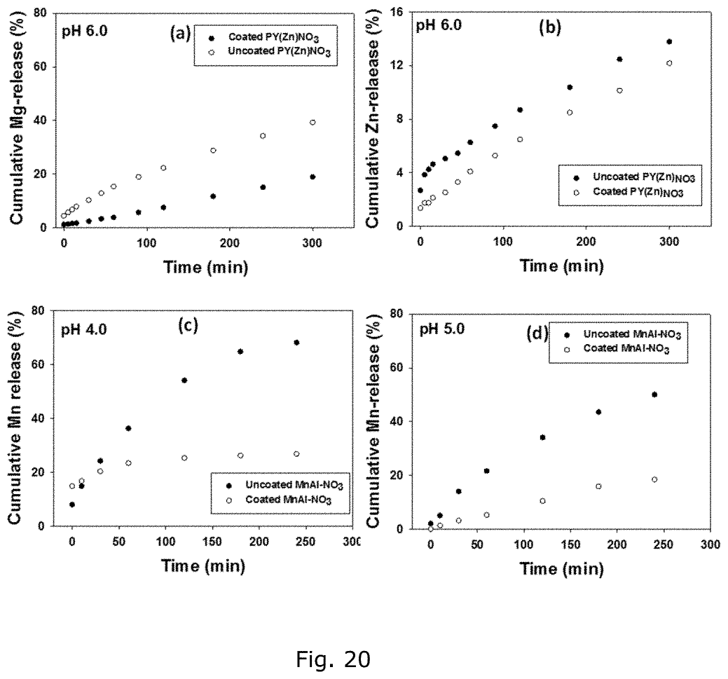

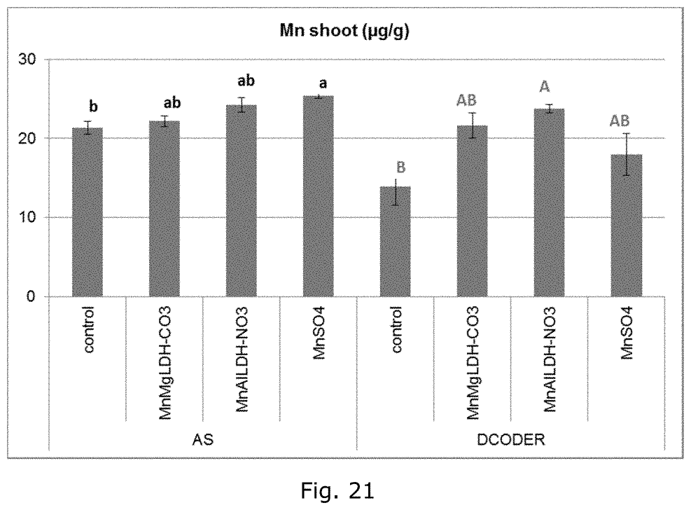

Release of Mg²⁺ and Zn²⁺ from PY(Zn)_{NO3}, at pH 6 and Mn from Mn(II)Al—NO₃ at pH 4 and 5 is plotted in FIG. 20 (a), (b), (c), and (d) respectively, as a function of reaction time. Comparison of metal release versus time profiles from both the coated and uncoated sample demonstrates that dissolution of coated LDH is greatly reduced as compared to non-coated one. For PY(Zn)_{NO3}, at a moderately acidic pH of 6, the maximum relative amount of released Mg²⁺ from uncoated sample in 5 hours is around 40%, which upon Si-coating reduces to half. However Zn-release from the same compound reduces roughly 2% after the surface modification. A large amount of Zn²⁺ is adsorbed on the Fe(III) (hydr)oxide phase that is formed during the release reaction; therefore, lesser Zn²⁺ was released compared to Mg²⁺, demonstrating that Zn²⁺ was increasingly retained in the solid phase. At pH 4, Mn-release from MnAl—NO₃ decreased from 70% to 25% after surface modification. The released amount of Mn is reduced from 50% to almost 20% after coating at a higher pH 5.

Physicochemical characterizations along with the metal release data revealed that the surfaces of pristine LDHs were effectively modified with minimal content of silica which is reflected by the suppressed dissolution of LDHs after coating. This is an effective modification of pH-responsive nanocarriers with the potential of use in pH-triggered delivery system.

### Example 13: Demonstration of Uptake in Barley and Maize Plants on Soil Growing Media

Two experiments in soil growing media were performed to demonstrate the effect of the composites prepared with macronutrient fertilizer granules covered with the Mn and Zn sources. The macronutrient granules selected were: AS: ammonium sulfate (15 mmol N/g granule), and DCODER: an N-P-K granule containing 15 mmol N/g, 0.85 mmol P/g, 1.27 mmol K/g, 0.5 mmol Mg/g granule). N is presented in an equilibrated mixture of ammonium and nitrate.

Table 14 shows an overview of the experiment with composites comprising LDH with Mn, and Table 15 shows an overview of the experiment with composites comprising LDH with Zn.

TABLE 14
Experiments with composites comprising LDH comprising Mn

| Fertilizer granules | Fertilizer granules covered by | |
|---|---|---|
| Ammonium sulfate (AS) | — | |
| Ammonium sulfate (AS) | Mn-LDH-CO3 | |
| Ammonium sulfate (AS) | Mn-LDH-NO3 | |
| Ammonium sulfate (AS) | MnSO₄ | |
| DCODER | — | |
| DCODER | Mn-LDH-CO3 | |
| DCODER | Mn-LDH-NO3 | |
| DCODER | MnSO4 | |
| Total treatments + controls | 8 | |
| Replicates and total | 4 | 32 |

TABLE 15
Experiments with composites comprising LDH comprising Zn.

| Fertilizer granules | Fertilizer granules covered by | |
|---|---|---|
| Ammonium sulfate (AS) | — | |
| Ammonium sulfate (AS) | Zn-LDH-CO3 | |
| Ammonium sulfate (AS) | ZnSO₄ | |
| DCODER | — | |
| DCODER | Zn-LDH-CO3 | |
| DCODER | ZnSO₄ | |
| Total treatments + controls | 6 | |
| Replicates and total | 4 | 24 |

The plant species, the soil, and the doses of fertilizer were different in each experiment in order to select the best characteristic of both parameters for the individual study of the Mn and Zn composites. The characteristics are further described in Table 16.

TABLE 16
The main characteristics related to materials and experimental
procedures used in the plant uptake experiments in soil growing media
with composites comprising LDH with Mn and Zn covered in granules.

| Parameter | Mn experiment | Zn experiment |
|---|---|---|
| Fertiliser | 1.5 g granules/plant; 3 mg | 1 g granule/plant; 1 mg Zn/plant |
| dose | Mn/plant | |
| Plant | Barley cv. Antonia | Maize cv. Ambition |
| Soil | Swedish soil mixture | calcareous soil (pH 8.0, and high |
| | | CaCO₃ content, 0.3 μg Zn/g soil, |
| | | based on DTPA extraction, |
| | | Soltanpour & Swarb, 1967) |
| Pots | Polyethylene cylinders | Polyethylene cylinders 0.7 L |
| | 0.7 L with 0.450 Kg of | with 0.6 Kg of soil:calcareous |
| | soil mixture: Sweden | sand mixture (50%:50%). |
| | (Kristianstad) mixed | |
| | with 40% v/v leca, 20% | |
| | v/v perlite, and 0.1% | |
| | (m/m) CaCO₃, pH 7.5. | |
| Replicates | 4 | 4 |
| Irrigation | P, K, Mg solution for AS | P, K, Mg solution for AS plants; |
| | plants; Distilled Water for | Distilled Water for DCODER |
| | DCODER plants, keeping | plants, keeping the 30% WHC |
| | the 30% WHC and con- | and controlled by weighing the |
| | trolled by weighing the | pots. |
| | pots. | |
| Growth | 23° C. day (14 h), 19° C. | 23° C. day (14 h), 19° C. night |
| Chamber | night (10 h), 40-60% | (10 h), 40-60% humidity |
| conditions | humidity | |
| Harvest | day 23 after the application | day 20 after the application of |
| | of the treatments in the | the treatments in the 14 days-old |
| | 14 days-old seedlings | seedlings |

Fertilizer Granule Preparation

Fertilizer granules: Separate treatments of fertilizers are used. The AS granules have a diameter of 1-2 mm while the DCODER granules have a diameter of 2.5 mm. Below is mentioned the different steps that were used for the granules composites preparation:

Talcum powder: Talcum powder (Mg₃Si₄O₁₀(OH)₂) was added to the surface of the granules to ensure that all treatments have the same powder covering (32 mg/g of fertilizer).

Uncoated controls: Control pots receive only ammonium granules (AS), or DCODER granules. The fertilizer controls were covered with a Timac Agro-provided oil and talcum powder.

Positive controls: Fertilizer granules covered in Timac Agro-provided oil and Mn and Zn sulfates.

LDH treatments: The fertilizer granules were covered in Timac Agro-provided oil and LDH in the lab in Copenhagen. The granules were coated to achieve 1.5 mg Mn/g granule and 1 mg Zn/g granule. For the Zn experiment, MgFeZnCO₃ LDH was used.

For the Mn experiment, both MgMnCO₃ and MnAlNO₃ were used. The two Mn LDHs were assayed since the redox state in them is different; in MgMnCO₃Mn was mainly present as Mn(III), while a mixture of Mn(II) and Mn(III) was present in MnAlNO₃,

Fertilizer coating: Fertilizers were coated as described in Example 2.

Seed Preparation and Planting

Barley (cv. Antonia) or maize (cv. Ambition) was grown. A sufficient number of seeds are germinated separately in vermiculite for 4 days (It is assumed that 50% of the seeds will not germinate). From the vermiculite, two strongly germinating seeds were chosen for each pot. Seedlings were transferred into pots filled with soil mixture previously incubated with the water. After addition of the germinated seeds, the pot soil was maintained moist for another 48 hours before reducing the moisture content to the target level (30%).

Fertilizer Addition to Soil—Fertilizer Amounts and Positions

The amounts added for each treatment is presented in Table 16. A similar Zn or Mn dose was applied in all the treatments (with a variation of an approximately 5%) in order to provide a N dose of 100 mmol N/plant and 150 mmol N/plant in the Zn and Mn experiments, respectively. In the pots, the fertilizer granules were placed in four equidistant locations around the pot at 2 cm depth from the surface.

Growth Conditions, Moisture Control and Irrigation Solution

After the soil, fertilizer and seeds were in the pot, nutrient solution was added to the soil in treatments with AS to provide similar P and K than those where DCODER was assayed, ensuring adequate macronutrients level.

The pots were placed in growth chambers, which were maintained in a 23° C. day (14 h), 19° C. night (10 h), 40-60% humidity. The pots were weighed frequently over the course of the experiment, and double-distilled water or nutrient solution added from above, to maintain the water content at 30% water holding capacity. The amount of added solution was adapted over the experiment according to the increase in plant weight. Pre-tests have shown that about 50 ml of water was lost per day in these growth conditions. The plants were monitored for signs of nutrient deficiency.

Sampling and Analysis

Shoot Harvesting

Plants were sampled after 23 days (barley) and 20 days (maize). The shoots were harvested (the whole part), washed with deionised water containing a few drops of detergent (Tween 20, Sigma Aldrich), then deionised water alone, and then twice in Milli-Q water (Millipore, Billerica, Mass., USA). After covering briefly in kitchen towel, the shoots were weighed for fresh weight, freeze-dried for 72 h and weighed for dry weight. Samples were milled for subsequent analysis of nutrient concentrations by ICP-OES.

Soil Samples

Homogenised samples of the whole pot in the maize experiment and separating the rhizospheric and the bulk soil in the barley experiment were taken. pH and soil micronutrient contents were analysed in the samples by the DTPA method (see below).

Soil pH was analysed by adding 25 ml of water to 10 g of soil in a falcon tube and manually stirring. Samples were left for 30 min. The suspension was stirred well just before immersing the electrode.

40 ml of DTPA extracting solution (Lindsay and Norwel, pH 7.3) was added to the 20 g of soil in a Falcon tube and agitated for 1 h. Samples were centrifuged (9,000 rpm for 5 min) and the solution filtered with Whatman filter paper. Samples were collected and acidified for subsequent analysis by AAS after acidification.

Results

FIG. 21 shows the Mn concentration in the shoots of barley plants grown under soil media with the treatments. Different letters indicate statistical differences according to the Duncan test at P≤0.05 for each group of treatments (AS and DCODER are analysed separately).

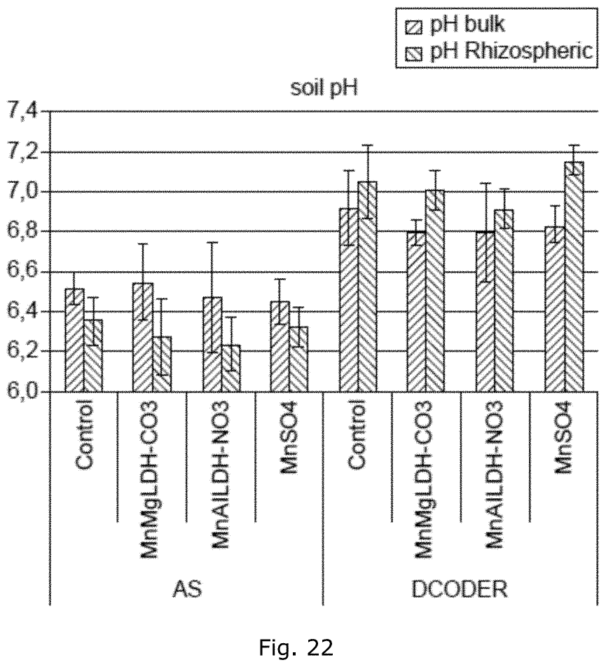

FIG. 22 shows the pH of the rhizospheric and bulk soil.

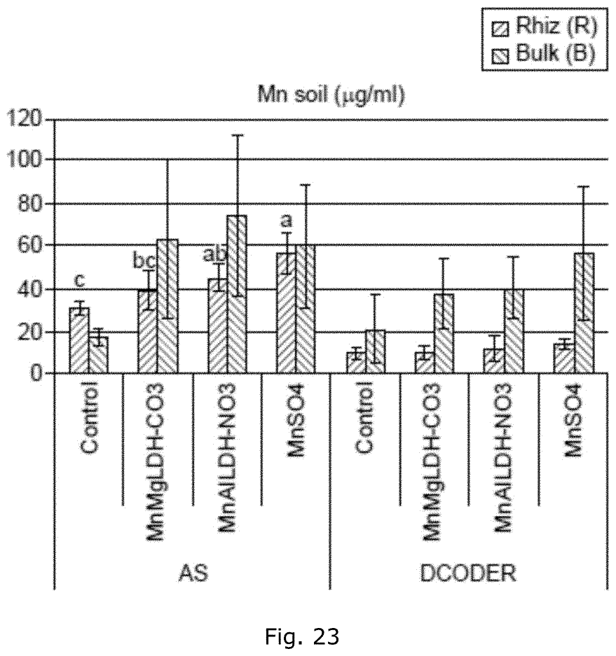

FIG. 23 shows the Mn concentration in the rhizospheric and bulk soil. Different letters indicate statistical differences according to the Duncan test at P≤0.05 for each group of treatments (AS and DCODER are analysed separately).

From FIG. 21 it is seen that the concentration of Mn in plants grown with the Mn composites were higher than plants grown under media without Mn (Control), demonstrating the efficient dissolution of Mn and its subsequent uptake by plants.

The pH (FIG. 22) was significantly lowered by AS treatments as compared to DCODER while no differences were found by comparing within the Mn sources or control. This pH decrease is probably responsible for a higher Mn solubilization from soil (FIG. 23) and the higher Mn uptake in AS plants (FIG. 21). However, despite similar pHs were recorded in DCODER plants, a higher Mn uptake was obtained by the application of Mn treatments especially the Mn LDH in the MnAlNO₃ form. In fact, by the treatment with DCODER+MnSO₄ a higher Mn solubilization to soil was recorded but this was not extended to Mn uptake, since lower Mn concentrations were obtained in these plants as compared to the Mn LDHs.

No significant differences were observed in the concentration of other nutrients, thus, the composite treatments did not alter other nutrients in plants. When comparing to MnSO₄ it is important to keep in mind that the high solubility of this salt may result in leaching and lower availability under field conditions. It may also be expected that the LDH's may improve even further in longer duration experiments.

From FIG. 21 it was seen that the concentration of Mn in plants grown with the Mn composites were higher than plants grown under media without Mn (Control), demonstrating the efficient dissolution of Mn and its subsequent uptake by plants.

The composites prepared with Zn-LDH and either AS or DCODER showed a similar positive effect in the plant growth or plant nutrient concentration.

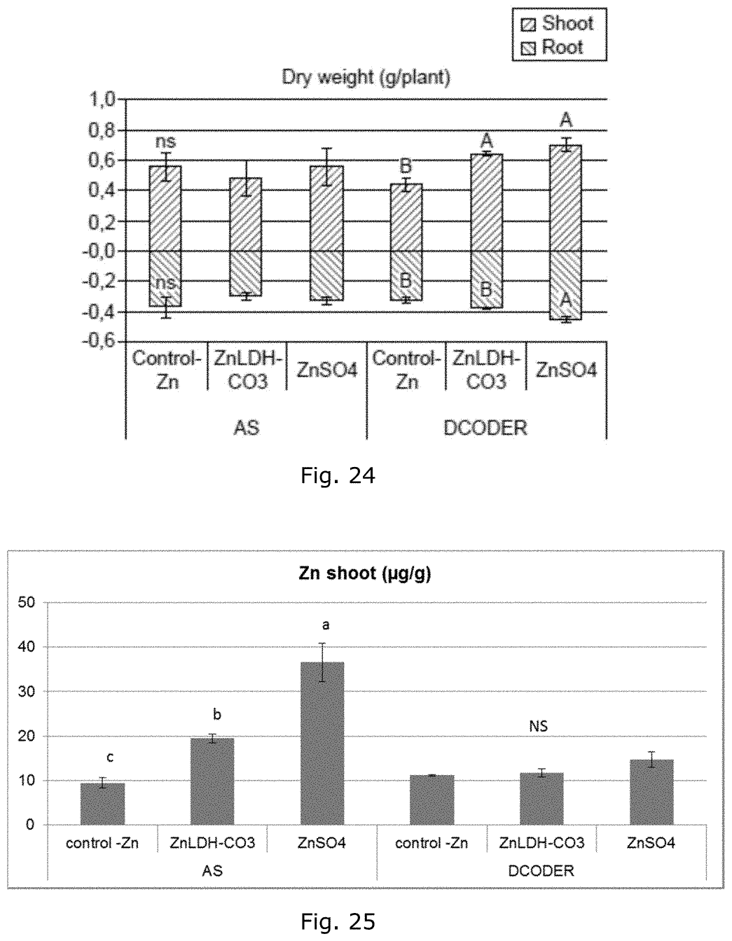

A clear positive effect in the dry mass of the plants was observed by the application of the DCODER composites covered with Zn sources (FIG. 24). In relation with the Zn concentration in the plants (FIG. 25), the composites with AS and the Zn sources showed an increment in the Zn concentration in shoots as compared with the control plants.

A lower Zn concentration was found in plants treated with the Zn-LDH which show up that the Zn-LDHs required longer period of time to release all the Zn available in the composite, based on its release-on-demand behavior. The high production of biomass in the case of Zn-LDH Decoder may be interpreted as follows: the release of Zn is adequate to sustain a high biomass production, but due to its slow release it makes the plant use Zn with high efficiency:

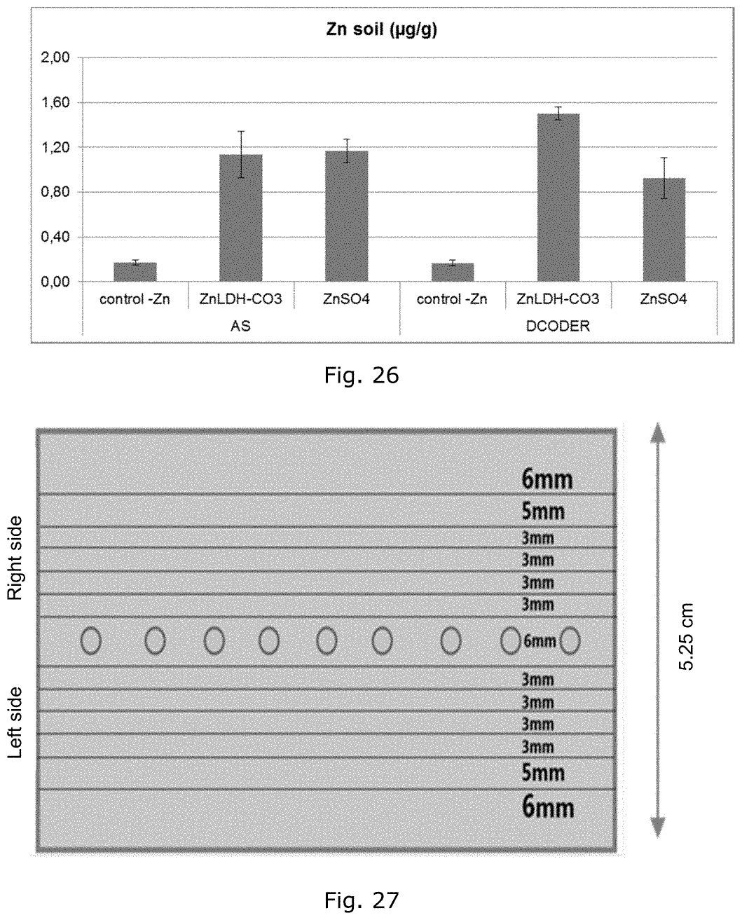

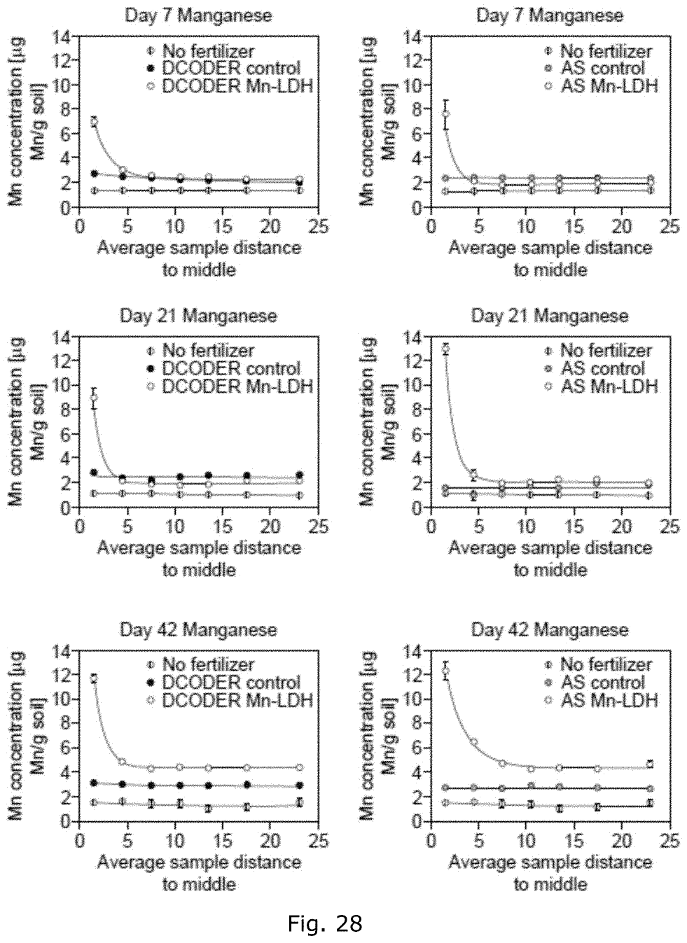

The slower release on demand behavior is corroborated by FIG. 26, where the Zn available in the soil after the experiment was clearly higher in the soil were the Zn LDH treatments were applied. The behavior of the composite prepared with the DCODER is specially relevant since the effect of the Zn-LDH covered in these granules induced a higher plant development, a higher Zn content in plant (Zn content values are obtained by the product of Zn concentration with dry mass), and, moreover, a higher Zn concentration is available in soil to be taken up by plants in longer time period.

### Example 14: Experiments in Column Diffusion Cells

Experimental Details

All diffusion cells are packed with the same soil, a Spanish calcareous soil (pH 7.3, high CaCO₃ content and low Zn and Mn concentration), sieved at 2 mm. Soil is pre-incubated at 60% WHC (13.04% GMC) for 1 week at 15 degrees. The soil is packed in the diffusion cells at 1.3 g/cm³ bulk density is for the soil.

The fertilizer granules added to each cell are evenly distributed in a symmetrical pattern on the surface. 105.66 g soil is packed on top of the granules placed in the soil. The amount of each fertilizer to achieve the same Mn or Zn concentration is specified below.

Fertilizer granules: NPK granules from Navarra (DCODER 7-10-6, ammonium sulphate (AS) granules from Sweden were covered with Zn-LDH (MgFeZn NO₃) or Mn-LDH (MnAl NO₃) as described in Examples 2 or 9. Control granules were added in order to achieve exactly the same nutrient concentration in all cells in order to compare them. Table 17 shows an overview of the samples.

TABLE 17
Samples for column diffusion cells

| | | Mn/Zn | | | Amount of |
|---|---|---|---|---|---|
| | | concen- | Target | Amount | control |
| | | tration | Mn/Zn | of | granules to |
| | | in granules | concen- | treated | achieve |
| | | [mg/g | tration | granules | same N |
| No. | Treatment | granule] | [mg] | [g] | content [g] |
| 1 | No fertilizer | 0 | 0.00 | 0.00 | 0 |
| 2 | DCODER-no | 0 | 0.00 | 0.00 | 0.77 |
| | coating | | | | |
| 3 | AS-no coating | 0 | 0.00 | 0.00 | 0.74 |
| 4 | DCODER-LDH- | 1.3 | 1.00 | 0.77 | 0.00 |
| | Mn—Al—NO₃ | | | | |
| 5 | AS-LDH- | 2.23 | 1.00 | 0.45 | 0.29 |
| | Mn—Al—NO₃ | | | | |
| 6 | DCODER- | 3.5 | 1.00 | 0.29 | 0.48 |
| | LDH-Zn—CO₃ | | | | |
| 7 | AS-LDH- | 3 | 1.00 | 0.33 | 0.41 |
| | Zn—CO₃ | | | | |

The experiment consisted in 7 treatments with 3 replicates, pooling of left and right side of APS layer, and 3 sampling dates. Height of the cylinder is 3·1.75 cm=5.25 cm. Middle found at 2.625 cm, this is where granules are placed and gives a total sampling distance of 26.3 mm−3 mm=23 mm apart from the middle layer. Middle layer (6 mm), +3 mm, +3-6 mm, +6-9 mm, +9-12 mmm, +12-17 mm, +17-23 mm (total 7 fractions) as illustrated in FIG. 31.

The packed diffusion cells were weighed and placed in a box and incubated at 15 degrees in the basement under a humid towel. The towel was kept moist during incubation by wetting it every 2-3 days. Diffusion cells were individually weighed and corrected for any loss of water by dropping water on the open surfaces at the ends every week. At the same time the diffusion cells were re-organized in the box to avoid special differences during incubation.

Sampling and Analysis

After 7, 21 and 42 days, incubation was over and the diffusion cells were sliced at distances shown in FIG. 31. Soil sliced on the right side and left side of the granules, is pooled together. The middle slice also contains the granules and is treated as a separate fraction with a length of 6 mm (this sample is named as slice 1; the rest of the samples are named as 2 to 7 as far as the distance to the fertilizer granules increased).

The Mn and Zn available in soil samples were determined by the DTPA extraction method described elsewhere, acidified and total Mn and Zn in the extracts determined by AAS.

Experimental Results

FIG. 32 below shows the diffusion of manganese through soils at neutral pH from LDH-coated fertiliser granules of D-CODER and Ammonium sulphate (AS) compared to soils containing a talc-coated granule (Control).

The results clearly show that Mn-LDH delivers Mn from both types of granules over the entire course of the experiment. This is seen from the increasing difference to the control fertiliser granule as well as the no-fertiliser control. Note that by the end of the experiment, the LDH treated granules have increased available Mn concentrations in the entire soil profile. The difference to the fertiliser control are statistically significant (p<0.001) for both D-CODER and AS.

### REFERENCES

[1] EP 1 661 876
[2] US 2011/296885
[3] Hansen & Taylor, 1991, Clay Minerals, vol 26: 507-525
[4] Miyata, S., 1975. Clays Clay Miner. 23, 369-375.
[5] Schmidt, S. B., Pedas, P., Laursen, K. H., Schjoerring, J. K., Husted, S., 2013. Plant and Soil 372, 417-429.
[6] J B Jones Jr, B Wolf, H A Mills (1991). Plant analysis handbook. A practical sampling, preparation, analysis, and interpretation guide, 213 pp

1.-20. (canceled)

21. A composite for a fertilizer, comprising:
a first particle comprising one or more macronutrients, and
at least one second particle comprising a layered double hydroxide (LDH) comprising at least one micronutrient,
wherein the at least one second particle is present on the surface of the first particle.

22. The composite according to claim 21, wherein the at least one second particle is a micro particle with a particle size equal to or below 10 μm.

23. The composite according to claim 21, wherein the LDH comprises one or more micronutrients selected from the group consisting of copper (Cu), iron (Fe(II)), manganese (Mn), molybdenum (Mo), zinc (Zn), boron (B), silicon (Si), cobalt (Co), vanadium (V), selenium (Se), and combinations thereof.

24. The composite according to claim 21, wherein the LDH comprises below 30 wt % of any of the at least one micronutrients.

25. The composite according to claim 21, wherein the LDH further comprises above 50 wt % of non-micronutrients.

26. The composite according to claim 21, wherein the LDH is selected from the group consisting of MgZnFe^{III}NO₃, MgZnFe^{III}CO₃, MgMn^{III}CO₃, and Mn^{II}AlNO₃.

27. The composite according to claim 21, wherein the LDH further comprises one or more anions selected from the group consisting of anions comprising selenium, anions of organo-metal complexes comprising divalent manganese, and combinations thereof.

28. The composite according to claim 21, wherein the LDH is further surface modified by sorption of silicic acids and/or organic polymers, and/or by a coating of silica particles.

29. The composite according to claim 21, wherein the at least one second particle covers the surface of the first particle with a coverage degree above 50%.

30. The composite according to claim 21, wherein the at least one second particle is coated on the surface of the first particle.

31. The composite according to claim 21, wherein the at least one second particle comprises below 30 wt % of the composite.

32. The composite according to claim 21, comprising below 9 wt % of any of the at least one micronutrients.

33. The composite according to claim 21, wherein the first particle is a granule.

34. The composite according to claim 33, wherein the first particle has a particle size between 0.5 mm-2 cm.

35. The composite according to claim 21, wherein the first particle comprises one or more macronutrients selected from the group consisting of: nitrogen (N), phosphorus (P), potassium (K), calcium (Ca), magnesium (Mg), sulfur (S), and combinations thereof.

36. The composite according to claim 21, wherein the first particle comprises nitrogen (N) in the form of ammonium (NH₄⁺), nitrate (NO₃⁻), and/or urea (CH₄N₂O).

37. The composite according to claim 36, wherein the first particle further comprises a nitrification inhibitor.

38. A method for fertilizing a plant, comprising the steps of:
providing the composite according to claim 21, and
adding the composite to the soil,
whereby the composite dissolves in the vicinity of the plant root, thereby supplying a micronutrient to the plant within a micronutrient sufficiency range.

39. The method according to claim 38, wherein the soil is selected from the group consisting of near neutral soils and alkaline soils.

40. The composite according to claim 21, wherein the at least one second particle is a micro particle with a particle size diameter between 0.1-1 μm.
